(19) United States
(12) Patent Application Publication
(10) Pub. No.: US 2021/0286104 A1
(43) Pub. Date: Sep. 16, 2021

(54) SYSTEMS, APPARATUS, AND METHODS OF WATERSHED MODELING AND ASSESSMENT

(71) Applicant: River Software Inc, Lakeside, MT (US)

(72) Inventors: Clint M. Brown, Lakeside, MT (US); Jason L. Powell, Hilsboro, OR (US)

(21) Appl. No.: 17/249,815

(22) Filed: Mar. 15, 2021

Related U.S. Application Data
(60) Provisional application No. 62/990,444, filed on Mar. 16, 2020.

(51) Int. Cl. G01V 99/00

(52) U.S. Cl. CPC G01V 99/005; G01C 13/00

(57) ABSTRACT

A watershed modeling and assessment system may input, process, analyze, and store natural resource data in the characterization, analysis, and assessment of watershed and natural river and stream systems and to develop hydraulic models of flow in open channel systems. The system may enable analysis of overall watershed reach information and analysis, survey data, longitudinal profiles, cross-sections, channel material or substrate characterization, images, flow measurements, and Rosgen classification (stream type). The system may also enable development of detailed hydraulic models utilizing equations, techniques, and methods by using measured data, derived data, and estimated data. The system may also enable reports based on each of these individual components.

### RELATED APPLICATIONS

This application claims priority to and the benefit of U.S. Provisional Patent Application No. 62/990,444, filed Mar. 16, 2020, which is hereby incorporated by reference herein in its entirety.

### TECHNICAL FIELD

The present disclosure relates to watershed analysis and more specifically to characterization, analysis, and assessment of watershed and natural river and stream systems and development hydraulic models of flow in open channel systems.

### BACKGROUND

Water may be important to life on Earth. Relative water availability may be a major factor for designating habitats for different living organisms. Knowledge of the factors that affect water systems may help provide responsible management of natural resources, including the water. Data-driven analysis and research may enable scientists, conservationists, and government to understand current study areas, create predictive models, anticipate changes, and react appropriately to current or predicted issues.

### BRIEF DESCRIPTION OF THE DRAWINGS

FIG. 1 shows a block diagram illustrating component architecture.

FIG. 2 shows an architecture diagram illustrating a dashboard module.

FIGS. 3-4 show an architecture diagram illustrating a survey data module.

FIGS. 5-6 show an architecture diagram illustrating a longitudinal profile analysis module.

FIGS. 7-8 show an architecture diagram illustrating a cross-section analysis module.

FIGS. 9-10 show an architecture diagram illustrating a pebble count analysis module.

FIGS. 11-12 shows an architecture diagram illustrating a hydraulic analysis module.

FIGS. 13-14 shows an architecture diagram illustrating a reports module.

FIGS. 15-16 shows an architecture diagram illustrating a images module.

FIGS. 17-18 shows an architecture diagram illustrating a flow measurements module.

FIGS. 19-20 shows an architecture diagram illustrating a Rosgen analysis module.

FIG. 21 shows a flowchart of a method for Rosgen classification.

FIG. 22 is a block diagram illustrating a computing system and components.

### DETAILED DESCRIPTION

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Techniques, apparatus and methods are disclosed that input, process, analyze, and store natural resource data in the characterization, analysis, and assessment of watershed and natural river and stream systems and to develop hydraulic models of flow in open channel systems. The system may enable analysis of overall watershed reach information and analysis, survey data, longitudinal profiles, cross-sections, channel material or substrate characterization, images, flow measurements, and Rosgen classification (stream type). The system may also enable development of detailed hydraulic models utilizing standard equations, techniques, and methods as well as new advancements. The system may also enable reports based on each of these individual components.

The system may not only be a benefit for its individual components, but also the combination of these various components and analytical tools working together in a package. This single package enables cross-integration between the individual components. This cross integration may improve efficiency and analytical quality and may directly link what may have previously been separate and distinct analytical tools and techniques.

Micro-scale data sharing and cross-integration may enable the software to automatically harvest data and information to populates it in another analytical module for use and processing.

Macro-scale cross-assimilation and data aggregation may involve the ability to make data harvests and utilizations in a non-automatic manner. In a hydraulic modeling example, the slopes may be automatically brought over and populated. There may be several pebble counts in the reach file and each may be accessed to provide a particle size or d50 value for the hydraulic model (assuming use of the Mannings' equation model). Although these pebble counts may be available, the pebble counts may or may not be brought over automatically. Besides this example, this availability occurs throughout the modules and/or software in various locations. This cross-assimilation and data aggregation may be beneficial, whether it is direct and automatic or indirect and user driven.

Survey Data Processing Module and Visualization may automate the processing and visually represent the survey data. The visualization component may be useful for understanding and for rectifying issues with the raw survey data (e.g., problem resolution). Survey information may be tied to reference elevation datums chosen and specified by the user.

The LP and Cross-Section Analysis Modules may allow for segmentation and subdivision in new ways. Tying a subdivision to the data and making this data structure usable within the module and transferable to other analysis modules may provide benefits. Creating segmentation in the analysis of longitudinal profiles may also provide benefits for the LP. This subdivision and segmentation may be done manually or automatically. This subdivision and segmentation may be based on survey characteristics (e.g., distance or elevation) or by geomorphic characterization (e.g., riffles and pools).

Data Separation may enable identification and separation of actual data, interpolated data, and user-specified data. A source of data may be important in any investigation or analysis. Maintaining the data source may be enabled by the systems. The system may recognize, maintain, and record the data and its unique characteristics. The system may enable distinct indicators between actual data (e.g., measured), interpolated data (e.g., derived), and user-specified data (e.g., estimated). The system may track and maintain these data characteristics. For example, the system may calculate/interpolate the bankfull elevation between two known elevations. This data may be stored as an interpolated elevation and not as an actual data point (e.g., measured) or as a user-specified data point (e.g., estimated). If the user switches modules, the interpolate data may be shown as interpolated data. The system maintains indicators of data source and this information may be clearly shown and available.

Report Generation includes a report generating engine that allows users to create a custom report. Each constituent component report may be customizable and automatically integrated into a report with pagination and other unifying attributes. The automation and auto-filling of report fields and the customization options is a benefit, in addition to taking each of these reports and combine them into a total report package.

In addition to standard image metadata, the system may associate unique watershed-specific and geomorphic attribute metadata with each image (e.g., bankfull, cross-section location, etc.). This additional information may enable a better image storage, filtering, retrieval, and use solution. This additional information may enable the automation of image insertion into reports as well as into the analysis modules. For example, this metadata may enable the system to automatically populate the Images tab in the LP module with the correct images for that LP.

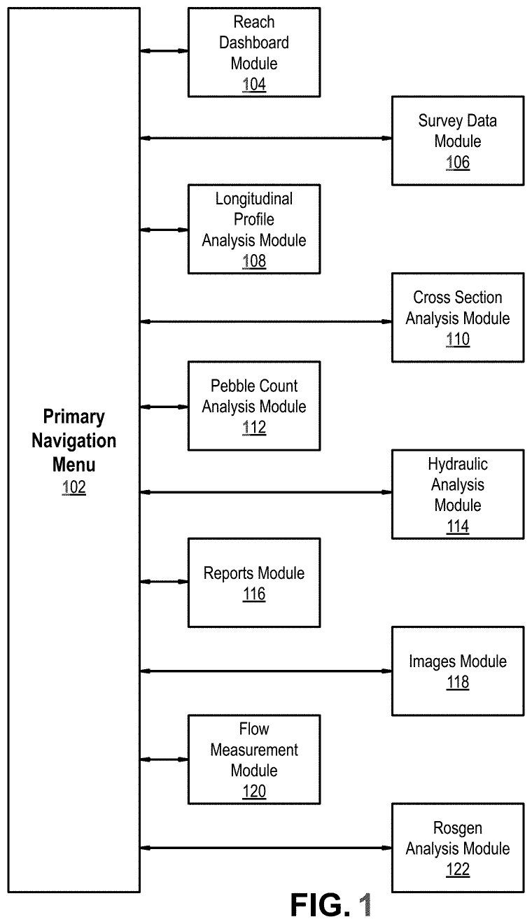

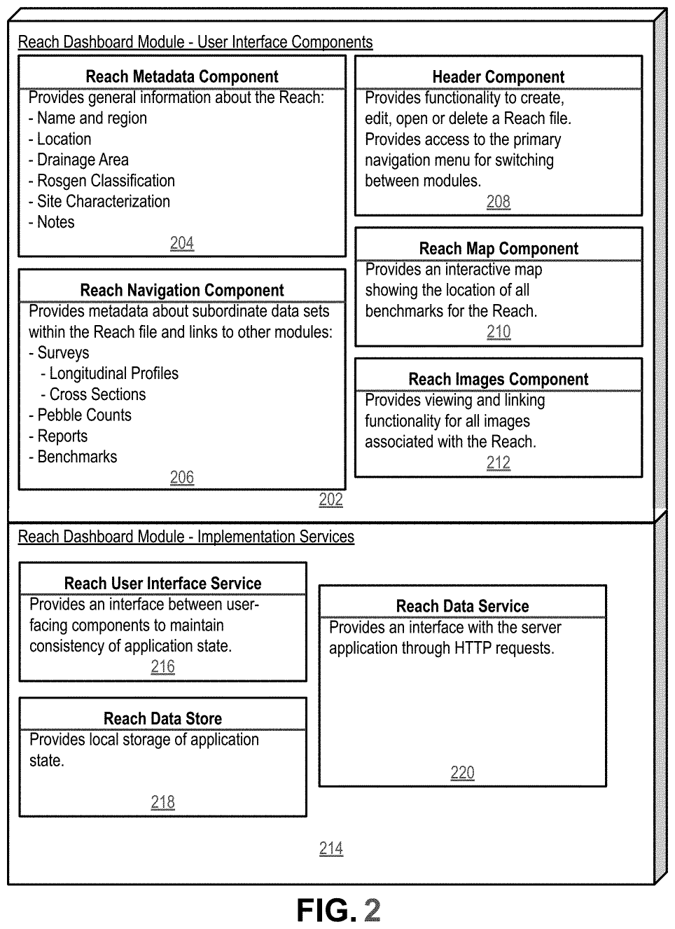

FIG. 1 shows a block diagram illustrating component architecture. In the user interface, a primary navigation menu 102 may link to a user interface for individual components, such as a reach dashboard module 104, survey data module 106, longitudinal profile analysis module 108, cross section analysis module 110, pebble count analysis module 112, hydraulic analysis module 114, reports module 116, images module 118, flow measurement module 120, and/or Rosgen analysis module 122. These individual modules are discussed in relation to FIGS. 2-11. The modules may use a central database and/or storage to share and/or pull data, enabling single data entry for multiple modules.

FIG. 2 shows an architecture diagram illustrating a dashboard module. The reach dashboard module may summarize general information for a detailed study area and enable geo-spatial referencing critical characteristics, analysis, and assessments. This summarizing and enabling may improve the quality of the specific analysis and assessment and/or correlation and comparison to other study areas or reach files. This may result in better micro-scale (e.g., specific subject area) analysis and assessment in the specific subject area, comparison and use in different subject areas resulting in better analysis and assessment, and for larger, macro-scale assimilation of characterization and quantification of smaller scale studies into a more far reaching, larger-scale assessment (e.g., a large drainage basin or hydro-physiographic province as opposed to a single watershed or particular segment of a watershed).

The Reach Dashboard Module may provide overall reach or study area information in distinct areas, for example, overall summary information/characterization, data tree of the individual file, map display of location and geospatial information, and/or pertinent images. A Header Component may provide additional functionality.

The Reach Dashboard Module may comprise user interface components 202 and implementation services 214. The user interface components 202 may include a Reach Metadata Component 204, Reach Navigation Component 206, Reach Map Component 208, Reach Images Component 210 and/or Header Component 212.

The Reach Metadata Component 204 may enable critical identifying file information for the individual file to be displayed (e.g., reach name, stream name, and region). An overall summary information for an individual file (e.g., specific study area) may show or display the location and geospatial coordinates (e.g., latitude and longitude) of the study area, the drainage area of the study area, what tributaries are impacted or related to the study area, the Rosgen classification (Level 1 and Level II) for the study area, the general site condition classification, and/or a summary of an impact assessment to the study area. A section may be included for the users to record critical information for this individual file that does not fall into one of the previous sections or information types. This information may become a basis for comparison, analysis, and assessment between individual files and/or for the larger-scale (macro-scale) comparison amongst many individual files.

The Reach Navigation Component 206 may provide a data tree that identifies and displays the component file(s) within the user's individual file that is currently open and available. This data tree may list files by the associated analysis component or module (e.g., surveys, hydro analysis, etc.). The user can expand or collapse the data tree so that progressively more, or less, detailed information is shown regarding the available information for a specific component or module. For example, expanding the survey portion of the data tree may show available survey files within an individual reach file.

A Reach Map Component may include an embedded map for visual display of the reach area and geospatial data. This map may be expanded to fill the viewable screen and collapsed to aid the user in analysis and assessment. The map's base layer may be changed to show the map with or without terrain interpretation or to use a satellite aerial photograph as the base. When geospatial coordinates have been associated with specific data points (e.g., the latitude and longitude for a specific benchmark), geospatially important data may also be shown on the map (e.g., benchmarks and other data points). Each data type may have individualized icons, symbols, and/or color. The scale of the map display may be changed (e.g., zoom in and zoom out), as well as moving the map around within the display window.

The Reach Images Component 210 may include an images viewer that displays images for the study area (e.g., photographs, aerial photographs, etc.). The images may have been associated with the individual file and designated as representative of either the overall reach (study area) or representative of specific portions of the study area. For example, a photograph that a user delineated as being representative of the entire study area may be shown. A photograph that is indicated as representative of a particular component of the study area file (e.g., representative of cross-section #2 or representative of pebble count #4) may be also be available for viewing in a viewer on this page.

The Header Component 212 may provide functionality to create, edit, open or delete Reach files. This component may also provide access to a primary navigation menu for switching between modules.

The implementation services 214 may include a reach user interface service 216, reach data store 218, and reach data service 220. The Reach User Interface Service 216 may enable communication between the user interface components. The Reach User Interface Service 216 may act as an intermediary between components. Messages pertaining to specific user actions within one component may be broadcast to other components that require the information. This broadcast may enable responses to user actions that take place in another component.

The Reach Data Store 218 may provide a local, in-memory representation of a currently open Reach file. This representation may be updated based on user actions. This updating enables other modules within the application to be synchronized to the current state of the Reach file.

The Reach Data Service 220 may provide an interface with the Server Application for purposes of storing and retrieving Reach file data from a remote database. Reach file data requests to the Server Application and responses from the Server Application may be routed through this service.

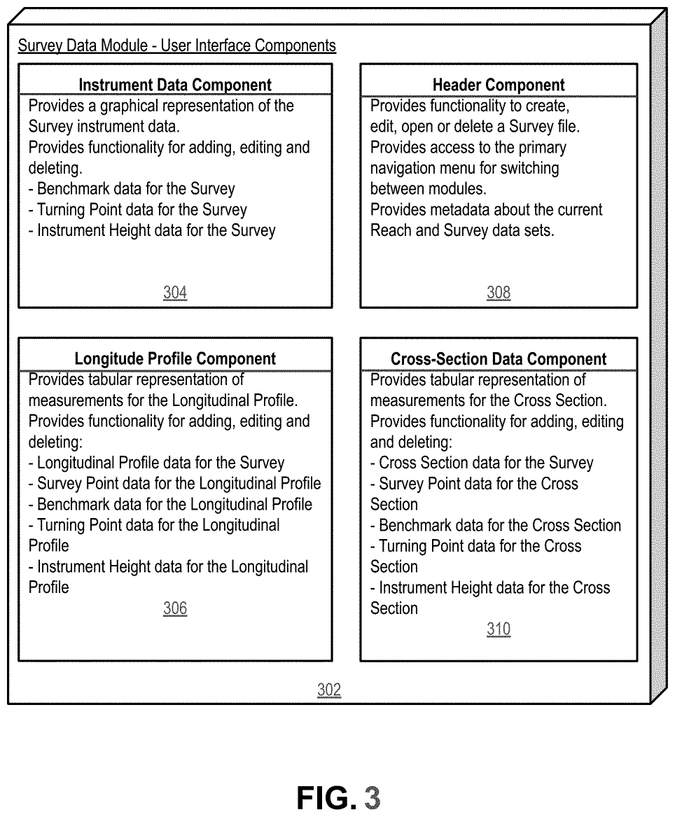

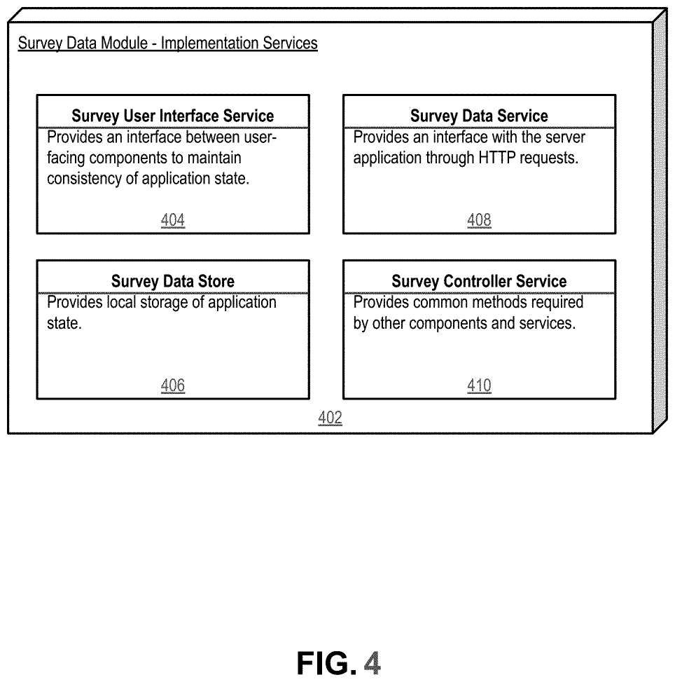

FIGS. 3-4 show an architecture diagram illustrating a survey data module. The Survey Data Module may provide for input and processing and verification of survey data (primarily two- and three-dimensional survey data) related to watershed assessment and characterization. The processed survey data may enable other analysis and modules to utilize the survey data for their functions and/or processing. This data may be available for use in the other primary analysis components/modules without outside data processing or re-entry of survey data information. This module allows a user to specify a reference elevation to which the survey data is referenced. This reference elevation may be either a true elevation (a public elevation datum) or an arbitrary elevation datum that is specified by the user. Besides individual data points, this module may also allow for the establishment of benchmarks, turning points (changes in instrument heights), and inclusion of existing benchmark elevations (either public or private). Survey data points may be, if enabled and/or used, geo-spatially referenced with latitude and longitudinal coordinates which allows for improving a quality of the specific analysis and assessment as well as correlation and comparison to other study areas or Reach files. A result may include better micro-scale (specific subject area) analysis and assessment, and/or improved comparison and use in different subject areas for analysis and assessment. The module may also allow for larger, macro-scale assimilation of characterization and quantification of smaller scale studies into a more far reaching, larger-scale assessment (e.g., a large drainage basin or hydro-physiographic province as opposed to a single watershed or particular segment of a watershed).

The Survey Data Module may enable a user to input field measurements (e.g., invert elevation measurements commonly referred to as foresight and backsight readings) and then calculate the elevations. The module may work in concert with accepted field techniques of watershed professionals and accept data directly from field notes. It may accept the type of survey data that watershed professionals collect, in the manner that they collect it, and processes it in a manner they may intuitively understand. A result of this industry-specific orientation may be quicker input, processing and analysis of survey data and a direct cost savings associated with this improved efficiency. Additionally, the improved efficiency may enable more productivity.

The Survey Data Module may include safeguards to protect data integrity and to aid in the verification of survey data. The survey module may determine if there are issues/problems within the survey data set and aid in resolving issues. The overall accuracy and precision of processed field measurements and survey data set may be analyzed, which may result in higher confidence in the survey data and all subsequent analysis. Basic coordinate and elevational transformations may be prepared. Resulting elevational changes may cascade throughout the survey data set. A survey may be closed, allowing for reasonable accuracy and precision determinations and elevational control comparisons.

The Survey Data Module may provide the survey information using components: an Instrument Data Component 304, a Longitudinal Profile Component 306, and a Cross-Section Component 310. These components may enable input, processing, and analysis of different data types. Instrument height information may be processed within the Instrument Data Component. Survey data associated with a longitudinal profile may be processed within the Longitudinal Profile Component. Survey data associated with a cross-section may be processed within the Cross-Section Component. Collectively, a user may be able to input and process varying survey data types for a complete watershed assessment and characterization of survey data.

These components may also include cross-component integration of the survey data. For example, information from the Instrument Data Component is available in both the Longitudinal Profile Component and the Cross-Section Component (e.g., a Benchmark in the Instrument Data Component may also be available in either of the other components). Annotations and cross-references may be shared between the individual components (e.g., a location of a cross-section or flow measurement may be referenced within the Longitudinal Profile Component).

The User Interface Components 302 may comprise an Instrument Data Component 304, a Longitudinal Profile Component 306, and a Cross-Section Component 310. The Instrument Data Component may provide an overview of the survey data within an individual survey file. The Instrument Data Component may contain: a graphical display unit, a benchmarks unit, a turning points unit, and an instrument heights unit.

The Graphical Display Unit may automatically update as a survey file is created and instrument data points are added, edited, or deleted. The graphical display unit may provide a visual summary of the components and overview of the Survey data set. The graphical display unit may use elevation on a vertical axis so that data being shown may be tied to its actual elevation (such as relative to the reference elevation datum). A scale on the vertical axis may automatically change and re-size to show pertinent data in the Survey file. A horizontal axis may not be scaled to a specific distance but may re-scale itself to allow for the display of information.

In the graphical display, individual instrument heights (elevation of the instrument) may be shown as horizontal lines. Each instrument height may be annotated with its name, elevation, and the corresponding survey data associated with each instrument height. For example, first and last longitudinal profile data points derived from each instrument height may be shown. Any cross-sections associated with each instrument height may also be listed.

Within the graphical display the benchmarks may also be displayed at a correct elevation (either specified or calculated) and labeled with a name. A visual connection may be made to the instrument height that they are connected with by a vertical line. Turning points may be special survey locations used when changing from one instrument height to a new instrument height, which may be associated with a move in the location of the measuring instrument to facilitate continued surveying. In the graphical display, the turning points may be shown at their calculated elevation and may be tied with vertical lines to both (e.g., two) instrument heights: the existing instrument height (foresight invert) and the new instrument height (backsight invert). Similar to the benchmarks, each turning point may also be labeled with its name.

Collectively, the graphical display unit may provide a visual summary of all the survey data and information in the individual survey file. The unit may provide an overview of the survey data. The graphical nature may provide an overview describing how the data was collected, input, and processed. The graphical display may relate each of the survey data points to its source and how it was derived. The graphical display may provide indications where there might be issues with the survey data set and how to correct any issues or problems. Finding a source of a survey error can be a very tedious and difficult process that the graphical display makes much simpler and more intuitive, for example, by helping to determine the issue, a cause of the issue, and how to resolve the problem. Some survey issues are difficult enough that some may choose to conduct a whole new survey. With this system, errors in the survey may have an increased chance to be identified. The impact of this may include substantial savings in time, accuracy, and improved efficiency.

The Benchmarks Unit may display Benchmarks within an individual Survey file and automatically update as Benchmarks are created (e.g., added), edited, or deleted. New benchmarks may be created through a user interface that allows the user to enter the information for the creation of a new Benchmark. A list of existing Benchmarks may be provided showing name, elevation and foresight reading (e.g., how the benchmarks' elevation was derived). Selecting a Benchmark from the list may result in a corresponding Benchmark indicator becoming highlighted in the graphical display to make a visual connection between the Benchmark and its associated Instrument Height. This visual connection may indicate how the benchmarks were derived using an intuitive connection between instrument height, foresight (invert) reading, and calculated elevation (where appropriate). If a benchmark is not connected to an existing elevation datum (e.g., either through user input error or by intent), this may be made visually obvious. This visual indication may result in a time saving because data input errors may be quickly discovered and corrected.

The Turning Points Unit may display Turning Points within an individual Survey file and automatically update a list of Turning Points as they are created (added), edited, or deleted. New Turning Points may be created using a user interface that enables entry of the information for the creation of a new Turning Point and the establishment of the resulting new Instrument Height. A list of existing Turning Points may display a name and the two elevations of the related Instruments Heights (ex. 1,040.00=>1,035.00—the elevation of the old Instrument Height and the elevation of the new Instrument Height). Foresight and backsight readings (e.g., how the benchmarks' elevation was derived) may also be displayed. Selecting a Turning Point from the list may result in a corresponding Turning Point indicator becoming highlighted in the graphical display to make a visual connection between the Turning Point and both of the associated Instrument Heights. This visual connection may indicate turning points and how they are used to transition from the existing instrument height to the new instrument height. This enables the intuitive connection between old instrument height, foresight (invert) reading, the calculated elevation of the turning point, the backsight (invert) reading, and the new calculated instrument height. If a turning point is not connected to an existing elevation datum (either through user input error or by intent), this may be made visually obvious. This indication may result in a time saving because data input errors can be discovered and corrected more quickly.

The Instrument Heights Unit may display Instrument Heights within an individual Survey file and automatically update the list of Instrument Heights as they are created (added), edited, or deleted. New instruments heights may be created through a user interface that enables entry of the information for the creation of a new Instrument Height. Creation of an Instrument Height may be done by either basing it on a measurement from an existing benchmark or arbitrarily specifying the elevation. The list of existing Instruments Heights may display name and elevation. Selecting an Instrument Height from the list may result in the corresponding Instrument Height indicator becoming highlighted in the graphical display to make a visual connection between the Instrument Height and any associated Benchmarks and Turning Points as well as other survey data (e.g., cross-sections). Instrument heights may be a foundation of the survey data and the basis from which all elevations are calculated. This visual connection may aid in identification of instrument heights. If an instrument height is not connected properly to the survey, the graphical display may indicate this disconnection indicating either an error in their data input or a gap in their field data that needs to be corrected.

The Longitudinal Profile Component 306 (Survey Data Module) enable inputting, processing, and analyzing survey data for longitudinal profiles. The Longitudinal Profile component 306 may include: general information and elevation controls unit, summary table unit, and individual data points table unit. Functionality may be provided to create, edit, open or delete Longitudinal Profile data sets.

The General Information and Elevation Control Unit may include basic information that affects the Survey data set for the Longitudinal Profiles. The user may open or edit an existing Longitudinal Profile or create a new Longitudinal Profile data set. The name of the Longitudinal Profile and the dates when the survey was conducted may be displayed.

Elevation controls that are used within the open Longitudinal Profile data set may be displayed including the Benchmarks, Turning Points and Instrument Heights. These lists may automatically update as control items are added to or referenced within the Longitudinal Profile data set. These basic elements may be added for use in the open Longitudinal Profile data set, and/or removed from the data set. For example, an Instrument Height in the Instrument Data Component may be created and used for a portion, or all, of a Longitudinal Profile. The height may be added to the active list so that it could be referenced and used within this survey sub-set (i.e.—within the current Longitudinal Profile).

If a user selects a particular Instrument Height from the list, then Survey Points derived from (or associated with) this Instrument Height may be highlighted in the LP Summary Table unit to make a visual connection between the Instrument Height and the individual Survey Points. As a particular Turning Point is selected from the list, the Turning Point becomes highlighted in the LP Summary Table unit to make a visual connection to the Turning Point and allow for the clear differentiation between the Survey Points before and after the Turning Point. As a particular Benchmark from the list is selected, the Benchmark may be highlighted in the LP Summary Table unit to make a visual connection to the Benchmark and survey data. The visual connection between the controls and the survey data may aid the understanding of the data and how it is processed.

The LP Summary Table Unit may include the processed survey data associated with the Longitudinal Profile. For each station in the Longitudinal Profile, the table may show the station name (ex. LP 0+30), distance, a description of the feature (e.g., Riffle), and then calculated elevations, if present, for geomorphic features (e.g., elevations for the left terrace, left bankfull indicator, left edge of water, thalweg, right edge of water, right bankfull, and the right terrace). Control elements may be automatically added as they are used within the survey data set. As survey data is entered into the Longitudinal Profile, the elevations may be calculated and information automatically added to the LP Summary Table unit. A selection of an existing station from within the LP Summary Table Unit may cause survey data for that station to be highlighted in the summary table. The Individual Data Point Table Unit may automatically fill with the corresponding detailed data for that station.

The Individual Data Point Table Unit may include the detailed survey data associated with a specific station of a Longitudinal Profile. New Survey Points for a Longitudinal Profile may be added. Existing points in this unit may also be edited. Survey Points may also be deleted from this unit. Entering data for a new profile station may be divided into sections: general information regarding the station and specific information for each of the geomorphic features.

When adding a new Survey Point to the Longitudinal Profile, functionality may be provided to select the Instrument Height that may be used for elevation calculations for that Survey Point. A user may specify a station location using the accepted stationing nomenclature (ex. LP 0+30) in the appropriate fields. The system may automatically calculate the distance along a longitudinal profile. The user may select or designate, if known, a channel feature (e.g., Top of Riffle). The system also may enable the reverse calculations. For example, the system may allow a user to enter distance. The system may convert distance to stationing nomenclature and fill that data field.

A user may enter surveyed invert readings for any of the geomorphic features. Actual field survey data may be entered in invert fields and other fields may be left blank if no data exists for that feature. Possible features include left terrace, left bankfull, left water's edge, thalweg (channel bottom), right water's edge, right bankfull, right terrace, etc. Invert foresight reading may be entered, and the elevation may be calculated. This entry may be repeated for each of the fields for which data exists. Site conditions (e.g., “bare soil/sand” or “Grass, Tall”) may be identified from a drop down menu of choices for each of the individual features. This is information may be embedded into and associated with the Survey Point and available in other portions of the system (e.g., hydraulic analysis). This entry may result in improved efficiency and accuracy because the site condition information is transferred only once from the surveyor's field notes and associated with the station and feature data (e.g., within the survey data set) while making it available for reference and use in the other modules.

An optional field may indicate confidence in a measurement. It is not uncommon for there to be some variability in a measurement or in a surveyor's confidence in a particular measurement. For example, the water surface measurement on one side may be easier to obtain on one side and more problematic on an opposite side. The result may show that the field measured invert foresights and the resulting calculated elevations are different even though they should be, theoretically, equivalent. This confidence may be reflected in the measurements and indicating which measurement is most accurate. Although both measurements may be part of the data set and maintained, the measurement that has been specified as being the most accurate may be preferentially used in analysis and graphing.

The Cross-Section Component 310 (Survey Data Module) may include an interface that enables input, processing, and analyzing the survey data for cross-sections. Similar to the Longitudinal Profile component, this component may include: general information unit and elevation controls unit, summary table unit, and individual data points table unit. The system may create, edit, open or delete Cross Section data sets.

The General Information and Elevation Control Unit may include basic information that affects the survey data for the cross-section(s). The unit may open or edit an existing Cross-Section data set or create a new Cross-Section data set. This unit may enable display the name of the cross-section and the dates when the survey was conducted.

This unit may display elevation controls that are used within the open Cross-Section survey including the Benchmarks, Turning Points and Instrument Heights. These lists may automatically update as control items are added to or referenced within the Cross-Section data set. The elements may be added for use in the open Cross-Section data set, or removed from the data set. For example, the user may have created an Instrument Height using the Instrument Data Module and use it for a portion, or all, of their Cross-Section. The user may add it to the active list so that it could be referenced and used within this survey sub-set (e.g., within the current Cross-Section).

If the user selects a particular Instrument Height from the list, then Survey Points that were derived from (or associated with) this Instrument Height may be highlighted in the XS Summary Table unit to make a visual connection between the Instrument Height the individual Survey Points. Selecting a particular Turning Point from the list, the Turning Point may be highlighted in the XS Summary Table unit to make a visual connection to the Turning Point and allow for the clear differentiation between the Survey Points before and after the Turning Point. Selecting a particular Benchmark from the list, the Benchmark may be highlighted in the XS Summary Table unit to make a visual connection to the Benchmark and the survey data. The visual connection between the controls and the survey data may indicate relationships of the data and how it is being processed.

The Cross-Section Summary Table Unit may include processed survey data associated with the Cross-Section. For each Survey Point in the Cross-Section, the table show the name or indicator (usually the geomorphic feature), the position or distance, the invert foresight reading, the calculated elevation, and the calculated stage height. Control elements may be automatically added as they are used within the survey data set. As survey data is entered into the Cross-Section, the elevations and stage heights may be calculated and the information may be automatically added to the Cross-Section Summary Table unit. If an existing Survey Point from within the Cross-Section Summary Table Unit is selected, survey data for that station may be highlighted in the summary table and the Individual Data Point Table unit may automatically fill with the corresponding detailed data for that Survey Point.

The Individual Data Point Table Unit may have all the detailed survey data associated with a specific Survey Point in the Cross-Section. New Survey Points for a Cross-Section may be added and the user can edit existing points in this unit. Survey Points may also be deleted from the Cross Section. Entering data for a new Cross-Section position may be divided into sections: general information regarding the position, specific elevational information, and confidence in measurement confidence accuracy.

To add a new data point to the Cross-Section, functionality may be provided to select the Instrument Height that will be used for all elevation calculations for that Survey Point. The distance of the data point along the cross-section in the appropriate field may be specified. The user may select or designate, if known, the geomorphic feature from the available drop down menu (e.g., Thalweg).

Field measurement for the foresight invert may be input and the actual elevation calculated. Site conditions may be specified (e.g., “bare soil/sand” or “Grass, Tall”) from a drop down menu of choices for each of the individual features. This information may be embedded into and associated with the Survey Point and available in other components or units (e.g., hydraulic analysis). This availability may result in improved efficiency and/or accuracy because the site condition information may be transferred only once from the surveyor's field notes and associated with the station and feature data (e.g., within the survey data set) while making it available for reference and use in the other modules.

An optional input field may establish confidence in a measurement. There may be some variability in a measurement or in a confidence in a particular measurement. For example, a water surface measurement on one side may be easier to obtain on one side and more problematic on an opposite side. The result may be that the field measured invert foresights and resulting calculated elevations may be different even though they should be, theoretically, equivalent. Confidence in the individual measurement's accuracy may be specified. Measurements may be maintained as part of the data set, but a measurement that has been specified as being the most accurate may be preferentially used in analysis and graphing.

In the Survey Data Module, a Header Component 308 may show what individual file the user has open (reach name, reach region, and level I Rosgen classification). The component may show identifying information of the specific survey unit that the user is currently working on (including the survey file's name, dates of collection, the reference datum and type, and the members of the survey crew). The Header Component may provide functionality to create, edit, open or delete Survey files. The component may also provide access to the primary navigation menu for switching between modules.

The Survey Data Module may include Implementation Services 402, including Survey Data User Interface Service 404, Survey Data Store Service 408, Survey Data Service 406, and Survey Data Controller Service 410.

The Survey Data User Interface Service 404 may enable communication between the user interface components. This service may act as an intermediary between components, so that messages pertaining to specific user actions within one component may be broadcast to other components that require that information. Thus, a component can respond to user actions that take place in another component.

The Survey Data Store Service 408 may provide a local, in-memory representation of the currently open Survey file. This representation may be updated based on user actions, enabling other modules within the application to be synchronized to a current state of the Survey file.

The Survey Data Service 406 may provide an interface with the Server Application for purposes of storing and retrieving Survey file data from the remote database. Survey file data requests to the Server Application and responses from the Server Application may be routed through this service.

The Survey Data Controller Service 410 may provide common methods for other Components and Services within the Survey Data Module.

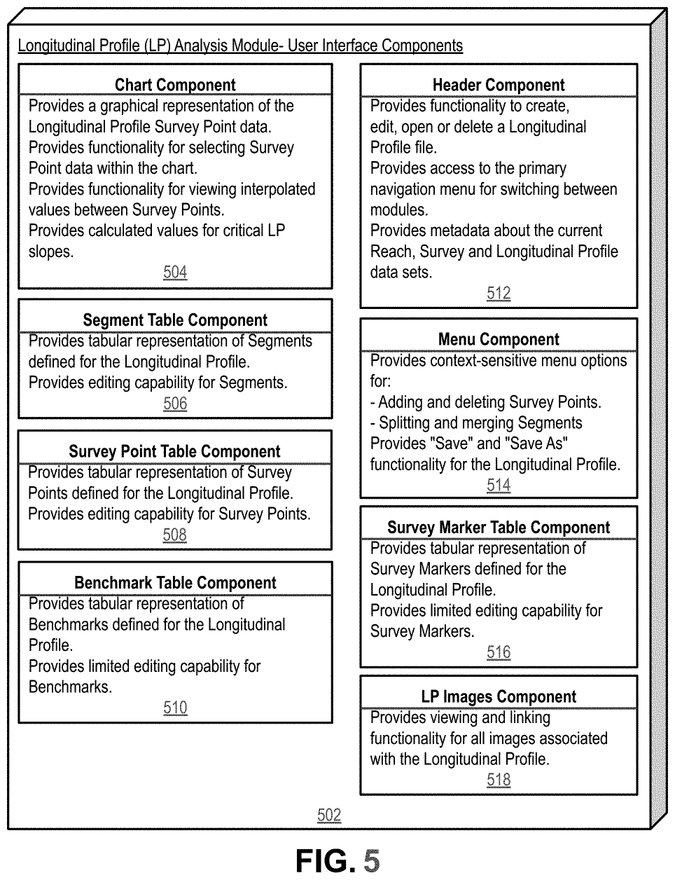

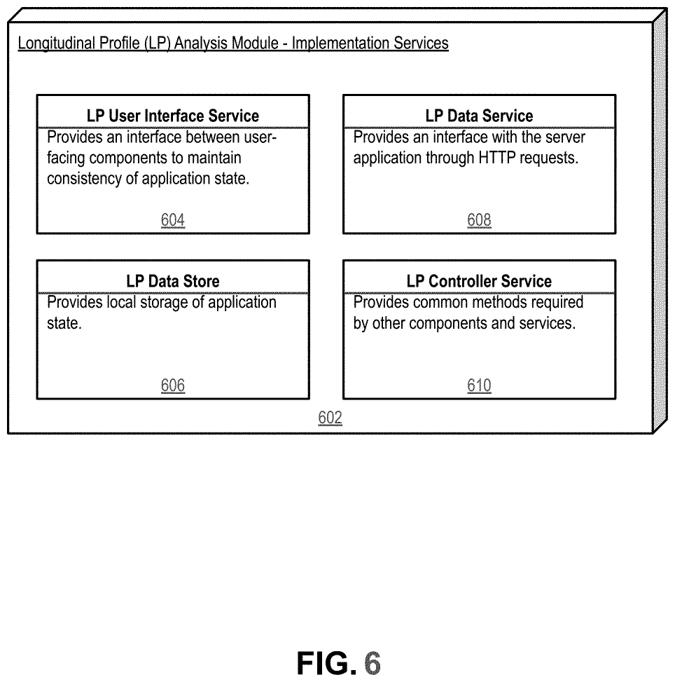

FIGS. 5-6 show an architecture diagram illustrating a longitudinal profile analysis module. The Longitudinal Profile Analysis Module may enable analyzing, graphing, and manipulating/editing/supplementing a Longitudinal Profile data set. The longitudinal profile analysis module may assist in this analysis and graphing enabling efficiency for watershed assessment and characterization.

The longitudinal profile analysis module may present and graph the Longitudinal Profile survey data, enabling interaction and refining of this data, and developing an informative representation of the longitudinal profile in both tabular and graphical formats. The processed survey data may become foundational data upon which the longitudinal profile is based. The longitudinal profile analysis module may interpolate points, when needed, using a linear algorithm. A user can supplement and add additional data points. Data types (e.g., surveyed, interpolated, or user-created) may be kept separate and distinct within the file to allow for the originating source to be maintained resulting in better interpretation and analysis. The user may also specify how and which data (any of the geomorphic features) is displayed within the graph.

Upon opening, data for the Longitudinal Profile data set may be analyzed for critical parameters and summarized in the Summary Analysis Table that is embedded into the graph. This summary analysis table may include overall information including, but not limited to, slope information in both length/length format and as a percentage value for the overall reach slope as well as for the key channel features (riffle and pool slopes). Minimum, maximum and average slope values may be calculated and the summary analysis table may automatically update its calculated values as the available data changes and/or the user edits or supplements the longitudinal profile data.

The Longitudinal Profile may be delineated and subdivided into channel feature Segments (e.g., riffle, pools, runs, and pool tailout). This comparison and analysis of similar features or channel segments may enable efficiency and differentiate them from the overall (un-segmented) characteristics of the longitudinal profile. This enables control and creation of these critical Segments for customization to promote better analysis.

Summary tables may be included to list the Survey Point data, Benchmarks, and Survey Markers for the Longitudinal Profile. Images associated with the LP may be available within the module. Each of these may aid in analysis of the longitudinal profile and improve the cross-integration of data and information between modules.

Control features may allow for new data and segments to be created, defined, or changed.

A benefit may be that the longitudinal profile data is approximately immediately available for use in the other primary analysis components/modules without the need for outside data processing or re-entry of the data.

The Longitudinal Profile analysis Module may enable analysis of the original profile data set and refine both the data set and the analysis. The system may work in concert with accepted field techniques of watershed professionals, including accepting, manipulating, and analyzing longitudinal profile data directly from field notes and incorporating post-field work editing. The result of this industry specific orientation may include quicker input, processing and analysis of longitudinal profile data. This may result in direct cost savings for the user associated with this improved efficiency.

By differentiating data types (e.g., surveyed, interpolated, or user-created), this module may include built-in safeguards to protect data integrity and to aid in the verification of longitudinal profile data.

The Longitudinal Profile analysis Module may provide an ability to edit, modify and supplement the longitudinal profile data for a complete watershed assessment and characterization of longitudinal profile data. The Longitudinal Profile analysis Module may include cross-component integration of the longitudinal profile data. For example, information from this module may be available in the hydrologic analysis module (e.g., calculated slope values may be available in other components). The Longitudinal Profile analysis Module may enable annotations and cross-references between the individual components (e.g., referencing the location of a cross-section or flow measurement within the longitudinal profile component).

Results of the Longitudinal Profile analysis may be available in tabular format or in graphical charts and plots. These results may be further customized by the user. Additional parameter fields may be added to the tables and adding additional chart types may be added and/or the charts can be inverted. The user may control how they develop and how they display their Longitudinal Profile analysis and modeling results. There may be already pre-built templates in the Reports Module so the user can easily output professional reports for all their Longitudinal Profile analysis.

The Longitudinal Profile analysis Module may include User Interface Components 602. The User Interface Components may include a Header Component 512, Chart Component 504, Segments Table Component 506, LP Survey Point Table Component 508, Benchmarks Table Component 510, Survey Markers Table Component 516, LP Images Component 518, and Menu Component 514.

In the Longitudinal Profile Analysis Module, the Header Component 512 enables display of (e.g., render) file information and metadata regarding the Reach, the Survey, and the specific Longitudinal Profile. For a watershed analysis, a number of individual associated files can become very extensive and clearly identifying the currently open files and their hierarchical relationship enables understanding the contextual setting of the longitudinal profile.

The Header Component may provide functionality to create, edit, open or delete Longitudinal Profile files. This component may enable access to the primary navigation menu for switching between modules.

The Chart Component 504 may communicate with a graphical display unit to render a graphical display. The graphical display may automatically update as the Longitudinal Profile file is created and data points are added, edited, or deleted. The graphical display may provide a visual summary of the components and overview of the Longitudinal Profile data set. The graphical display may use elevation on the vertical axis so that the data being shown may be tied to its actual elevation (relative to the reference elevation datum). The scale on the vertical axis may automatically change and re-size to show pertinent data in the Longitudinal Profile file. The graphical display may use distance on the horizontal axis so that the data being shown is tied to its actual distance or location along the length of the profile.

In the graphical display rendering, lines may connect similar data points. For example, the channel thalweg elevation points may be connected by a single line. The water surface elevation points may be connected by a single line. Other features, such as bankfull and terrace elevations, may also have their own lines. Each of these lines may be color-coded and distinguishable from the other lines. The channel elevation line may be further color coded by feature type such that individual Segments can be distinguished. For example, a color of the line for riffles may be different that the color of the line for a pool. Segments of the channel from the same feature type may be the same color (e.g., all riffle segments are the same color).

The graphical display rendering may show Benchmarks or Survey Markers associated with the Longitudinal Profile. If present in the Longitudinal Profile file, these may be located within the graphical display at the correct elevation and horizontal distance. Showing Benchmark locations on the display may indicate where there may be existing elevation control points within the profile. Showing the marker locations may aid in the cross-integration of data. For example, a marker may show a location of a flow measurement. Its location may be indicated within the profile, enabling a determination of the channel feature that this location falls under as well as to determine the slopes at this location. In another example, the marker may aid in locating a cross-section marker with its location along the longitudinal profile. This may enable a creation of a very specific three-dimensional interpretation (x,y, and z) for a sub-area within the profile. Also, this may allow for easy extraction of slope information if that cross-section is used for a specific hydrologic analysis. The locations of Images associated with the Longitudinal Profile may also be displayed in the Chart Component.

There may be a legend within the Chart Component that associates or sets forth the line color with the type of data (thalweg, water surface, bankfull or terrace) and the feature (riffle, pool, run, or pool tailout). The default setting may be for all data types to be pre-selected and displayed. The legend may be interactive and enable selection of what types (thalweg, water surface, bankfull or terrace) of data to display or not display. This may result in refining the displayed information to match analysis needs at the moment and easily change this as the needs or desires change. For example, an initial interest may occur in low-flow conditions and de-selecting the bankfull or terrace elevation lines (e.g., turn it off). After completing low-flow analysis, a detailed look at higher discharges (e.g., bankfull or even flood flows) may be chosen. The display may change to the bankfull line by receiving a selection (e.g., turn it on) and not display the water surface elevation line by de-selecting it (e.g., turn it off). The legend may have selectable buttons for the benchmarks, markers, and images. The default setting is for these data points to be displayed within the profile at their appropriate elevation and distance. Because the data points are selectable, the user can elect to not display this information within the Longitudinal Profile.

Over the longitudinal profile, there may be usually a significant difference between a total change in elevation and the distance or length. The display of the data may be optimized to allow for the clear distinction of features and individual data points. To accomplish this, a scale of the vertical axis may be significantly different from the horizontal scale. This may result in a display that has vertical exaggeration. Vertical exaggeration and its effects on a display may be calculated and displayed. The module may dynamically calculate and prominently show vertical exaggeration in the graphical display. As the display changes either through a change in data or if the user changes the view (e.g., zooms into a portion of the profile), the vertical exaggeration may be re-calculated and shown so that the displayed value reflects the current view.

The module may show the longitudinal profile in the graphical display. It may automatically optimize the vertical and horizontal scales to accomplish this while also providing for the largest possible vertical scale so that the individual data points are as distinct as possible. A user may want to focus their interest on a specific portion of the profile or may need to increase the scale (e.g., enlarge the graph) to more clearly refine the view. For example, if the profile is extremely long, the user may need to view it in smaller portions for analysis (e.g., enlarge it). Controls may be used to change the scale and shrink or enlarge the display (e.g., zoom in and zoom out). The controls may alter the view so that a portion of the total longitudinal profile is shown. This enlarged view may be moved to the left and right allowing the desired zoom level to be maintained while the user changes the portion of the longitudinal profile that is being shown. The vertical exaggeration may be different from the original display and a new vertical exaggeration value may be calculated and displayed with each change of the graphical display. This enables an accurate value of the vertical exaggeration of the current graphical display.

Another feature of the Chart Component includes the display rendering the known or calculated distance and elevation at any point in the profile. Elevation and distance information for points between Survey Points may be calculated automatically.

By its nature and the reality of field data collection, a longitudinal profile may be comprised of a majority of interpolated elevations based upon a limited number of known elevations for each of the data types. Manually calculating elevations for a desired location may be a time consuming, tedious, and error prone. By making available pertinent information at any distance along the longitudinal profile may reduce the time to adequately analyze the profile data and dramatically improve accuracy. Another benefit may be quick customization and refinement of the longitudinal profile data set if a point is inserted or a segment broken or a new segment boundary is created. Without this feature, these may be cumbersome, error-prone and difficult issues.

The graphical component may be a visual summary of the Longitudinal Profile data and information in the individual file. This may provide a user with a unique overview of the Longitudinal Profile data. The graphical nature may provide an overview and enable understanding of how the field derived elevations for each data type (e.g., channel thalweg and water surface elevation) inter-relate to each other at each point throughout and along the profile and how they relate to other points upstream and downstream. It also provides an efficient way to differentiate between an actual surveyed elevation and an interpolated or calculated elevations. The Chart Component also may define areas that might need or require supplemental elevation data for refinement and may be used to define further data collection efforts. The graphical display may enable determining where there might be issues with survey data set and how to correct issues or problems. A benefit of this component of may be a better or more-refined analysis and savings in time, better accuracy, and/or improved efficiency.

The Embedded Summary Analysis Table may be imbedded within the Chart Component of the Longitudinal Profile Analysis Module. These table(s) may provide summary information for quick review. A general longitudinal slope summary table may provide the change in elevation, distance, and the slope in both length/length and percentage formats. A default setting may be for this table to provide this information and calculated values for the overall bankfull data type set and for the water surface data type set. This may be changed in the preferences settings to add other data types (e.g., channel bottom and/or terrace elevations). This is a summary or overview of characteristics or attributes of the longitudinal profile (e.g., describes total changes over the entire length of the profile). The summary analysis table may be another place where the system cross-integrates data between modules by automatically making these parameters available to other modules. For example, the overall parameters (e.g., overall reach slope) may be automatically available to the Rosgen Classification module to aid in the reach classification.

There may be a feature specific slope summary table that provides the slopes within the longitudinal profile for each of the features. This module may calculate and provide the average slope of each feature, as well as the minimum and maximum slopes of the feature within the longitudinal profile. A default display setting for this table may be to show riffle and pool slopes, but additional features may be added in the preferences interface. A default setting for these calculations may be to use and may be based upon the water surface elevations. The preferences settings may be used to add other data types (e.g., bankfull, or channel bottom or terrace elevations).

The system may display the overall average slope of a feature within the longitudinal profile, and/or the minimum and maximum slopes. For example, a user may observe signs of excessive sediment deposition and suspect there is a sediment transport issue. The user may seek the minimum slope exhibited in the riffles and to perform a detailed sediment transport and bed shear stress calculation for this minimum riffle slope. Another example of the benefits of these values and cross-integration may include performing a hydrologic analysis using a maximum pool slope to determine water velocities to see if the results are too high for fish to utilize for resting areas.

The Segments Table Component 506 may enable sub-dividing the Longitudinal Profile into more useful sections and associate a Segment with a feature type. This component may comprise a table that displays the label, position, feature type, and other information pertinent to the Segment. Control may be given to sub-divide the Longitudinal Profile data and assign Segments to specific features.

There may be a connection between the Segments Table Component and the Chart component. For example, as Segments are created and modified, the graphical display may automatically update to show the changes (e.g., when Segments are created (added), edited, or deleted). Selecting an existing Segment from within the Segments Table Component may cause several changes. The Segment may be highlighted in the Segments Table Component. The selected Segment may be highlighted in the Chart Component to make a visual connection to and show the Segment in the graph of the longitudinal profile., The individual data points within that Segment may be highlighted in the survey unit of the Individual Station Summary Table. The line color may change for that segment to reflect the feature type that has been assigned to the segment. For example, if a Segment is created and delineates a pool, then the line color assigned to the channel bottom line within the graph of the Longitudinal Profile may change to reflect that it is now designated as a pool feature type. These indicators may enable a clear visual connection between the Segment, the graph of the Longitudinal Profile, and what specific individual Survey Points are found within the Segment. This visual connection may aid understanding the Segments and how they were derived with an intuitive connection between data points and elevations within the Segment, its boundaries or delineators, and the graph of the Longitudinal Profile.

The LP Survey Point Table Component 508 may be an interface for the user to the Longitudinal Profile data and/or the underlying and constituent data that comprise the profile (which may exclude Segments which are found in the Segments Table Component). This component may interact with other components (e.g., the Chart Component and Segments Table Components) to enable analysis and editing tools for the Longitudinal Profiles. Collectively, the components of the Longitudinal Profile Analysis Module may provide a total picture of the Longitudinal Profile data as well as any related information that is associated. As such, the individual station summary table component may serve as part of the Longitudinal Profile and its analysis.

Each data set (point or distance) within the Longitudinal Profile may contain the stationing, the distance, specific elevations, the instrument height as well as an area for notes for that data set. This unit may be automatically populated with the processed survey information for the Longitudinal Profile. The stationing may be in the industry accepted form (e.g., LP 2+30) for a distance of 230 along the longitudinal profile. The station distance may be shown for users who may be less familiar with profile stationing nomenclature. In this table, elevations may provide for principal features of the longitudinal profile including the channel thalweg (bed elevation), the water surface elevation, the bankfull elevation, and the terrace elevation. The instrument height may also be shown for each station to understand and retrace to the source of the elevation data. This may visually aid in the profile research for data that seems incorrect and investigation of the anomaly.

It should be noted that for the analysis of the longitudinal profile, the survey data set may be condensed for some of the features. Specifically, when there are two elevations for a feature, only one elevation may be shown in the table. An example of this may be for the water surface elevations, the bankfull elevations and the terrace elevations which each may have the potential for there to be two or more distinct elevations (e.g., left and right). In cases where the data set includes two elevations for a feature, the system may utilize and display the elevation that was calculated from a measurement that comprises a higher user specified confidence. In cases where there are two elevations for a feature and neither has been designated as the confident measurement, then the system may calculate an average value of the two and display the calculated elevation in the Survey Points Unit table.

In some situations, there may be no data present for a particular feature. There may be gaps in the data set where there is no surveyed elevation data for a specific feature at a specific location. For example, no data may be available or collected for the bankfull elevation at a specific station. In this case, there may be no calculated elevation coming out of the survey data set in this feature field for that location (e.g., station). Without solving this issue, this may indicate that the longitudinal profile may have gaps for occurrences when data was unavailable and the value of the longitudinal profile may be compromised. Interpolating an elevation may predict the expected elevation based on the elevations immediately upstream and downstream to fill this void and complete the longitudinal profile.

In the Survey Points Table Component within the Longitudinal Profile Analysis Module, the display (font and color) for elevation may be coded to indicate its source. As an example, elevations that are derived from the survey may be shown in black, elevations that the system interpolated or created may be shown in yellow, and elevations that are user created or added to the file may be shown in black italics. This may be standardized throughout the modules, enabling understanding of the source of the elevation data no matter what module they are in.

A small notes field may be provided so for a brief description or additional pertinent information to associate with a specific station along the longitudinal profile.

The Benchmarks Table Component 510 may display Benchmarks that are found within the Longitudinal Profile data set. This list may be automatically updated as benchmarks are created (added), edited, or deleted and associated with the Longitudinal Profile. The label or name, position, elevation, identifying note and other information may be displayed for each Benchmark. If the user selects a particular Benchmark, then the displayed information may be highlighted within the table and the Benchmark may be highlighted in the Chart Component to make a visual connection between the Benchmark data and its position on the graph of the Longitudinal Profile. This visual connection may aid in understanding the Benchmarks and how they relate both positionally and with elevation to a longitudinal profile. This may enable intuitive connection between the longitudinal profile and the nearest primary elevation controls.

The Survey Markers Table Component 516 may enable association of unrelated information or data with a specific location along the longitudinal profile. For example, a location of cross-sections may be associated to its location along the profile. Other examples may include noting where pebble count substrate characterizations were collected, or where a flow measurement was performed, etc. For reference and cross-integration, this information may be stored as Survey Markers within a Longitudinal Profile data set.

The Survey Markers Table Component may render Survey Markers that have been associated with the Longitudinal Profile data set. This list may be automatically updated as Survey Markers are created (added), edited, or deleted and associated with the Longitudinal Profile. In this table, the station, position or distance, identifying note and other information may be displayed for each Survey Marker. If a particular Survey Marker is selected, then the displayed information may be highlighted within the table and the marker becomes highlighted in the Chart Component to make a visual connection between the Survey Marker data and its position on the graph of the Longitudinal Profile. This visual connection may aid understanding of the Survey Markers and how they relate both positionally and with elevation to the longitudinal profile. This may enable intuitive connection between the longitudinal profile and the specific marker.

The LP Images Component 518 may associate images within the profile file and with a specific location along the Longitudinal Profile. The uploading of images may be completed within a different major module (e.g., the Images Module). Images uploaded that are associated with the Longitudinal Profile may be available in this unit. The user can quickly refer to a picture when working within their Longitudinal Profile and they will know the location of the picture within the profile. This adds additional layer of information that is available to the user to aid in a more complete representation of the longitudinal profile.

The LP Images Component may display images that have been associated with the Longitudinal Profile data set. This list may be automatically updated as images are created (added), edited, or deleted and associated with the Longitudinal Profile. If the user selects a particular image, then the image icon may be highlighted in the Chart Component to make a visual connection between the image and its position on the graph of the longitudinal profile. This visual connection may aid understanding of the images and how they relate both positionally and with elevation to the longitudinal profile. This may enable intuitive connection between the Longitudinal Profile and the specific Image.

The Menu Component 514 may include several user options that allow for the manipulation of the Longitudinal Profile data. The controls may allow for: merging Segments, adding a Survey Point, splitting Segments, adding a Survey Marker, saving, and save as. Each of these action buttons may serve a specific purpose.

The “merge Segments” option may allow for two Segments to be joined together. The “split Segments” option may allow for a Segment to be split into two different Segments at a specified point. The “add a Survey Point” option may allow creating a new user-specified Survey Point within the Longitudinal Profile. The “add a Survey Marker” button may allow for the creation of or adding a Survey Marker to the Longitudinal Profile data set. The save button may be used when a Longitudinal Profile data set has been modified and the user wants to save the current data. Finally, there may be a save as button that allows the user to duplicate the Longitudinal Profile file with a new name (e.g., create a clone of the current data set).

The Longitudinal Profile Analysis Module may comprise Implementation Services 602. The implementation services 602 may include a LP User Interface Service 604, a LP Data Store Service 606, a LP Data Service 608 and/or a LP Controller Service 610. The LP User Interface Service 604 may enable communication between the user interface components. This service may act as an intermediary between components, so that messages pertaining to specific user actions within one component can be broadcast to other components that require that information. Thus, a component can respond to user actions that take place in another component.

The LP Data Store Service 606 may provide a local, in-memory representation of the currently open Longitudinal Profile file. This representation may be updated based on user actions, so that other modules within the application are all synchronized to the current state of the Longitudinal Profile file.

The LP Data Service 608 may provide an interface with the Server Application for purposes of storing and retrieving Longitudinal Profile file data from the remote database. Longitudinal Profile file data requests to the Server Application and responses from the Server Application may be routed through this service.

The LP Controller Service 610 provide common methods for other Components and Services within the Longitudinal Profile Analysis Module.

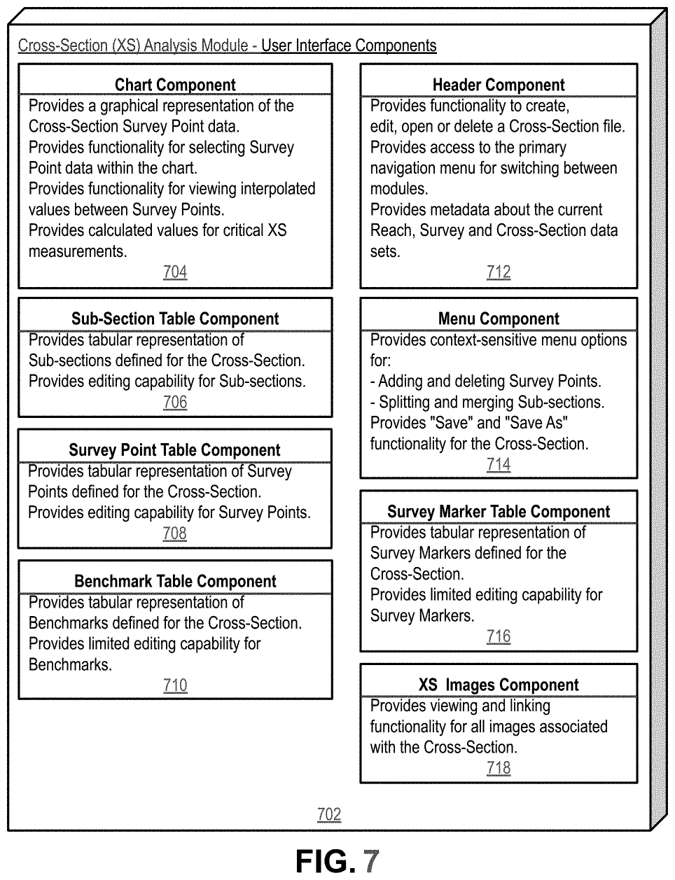

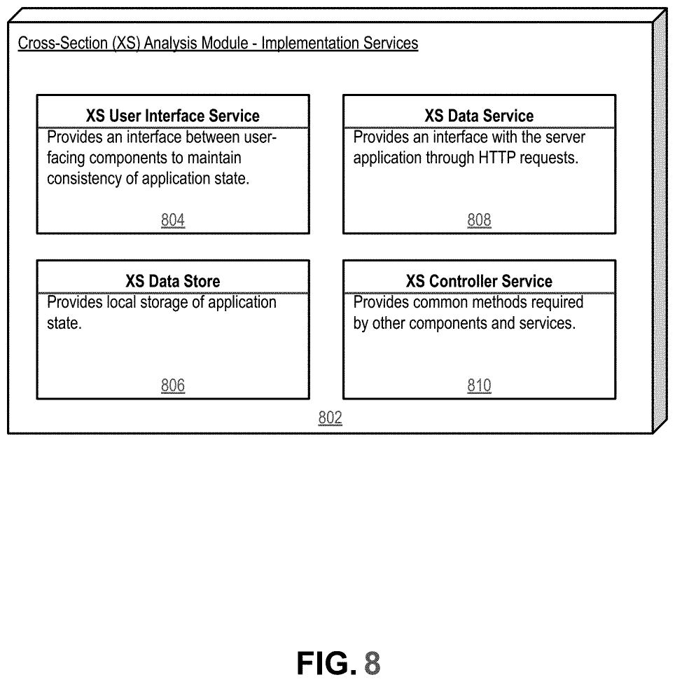

FIGS. 7-8 show an architecture diagram illustrating a cross-section analysis module. The Cross-Section Analysis Module provides a user with a critical ability to analyze, graph, and to manipulate/edit/supplement a cross-section. The system assists in this analysis and graphing which is an absolute core function for watershed assessment and characterization. For analysis and graphing, the Longitudinal Profile Module (previously discussed) works with Longitudinal Profile data and the Cross-Section Module (this module) works with Cross-Sectional data. Although the modules work with different data sets and perform different types of analysis, the system's interface for each is intentionally designed to be similar to maintain consistency for a user.

The system may be designed to present and graph the Cross-Section survey data, allow for the user to interact and refine this data, and to develop the most informative representation of the cross-section in both tabular and graphical formats. The processed Survey data may be a foundation upon which the Cross-Section is based. The system may interpolate points when needed and the user can supplement and add additional Survey Points. Data types (e.g., surveyed, interpolated, or user-created) may be kept separate and distinct within the file to allow for the data's originating source to be maintained, enabling better interpretation and analysis. The user may specify how and which data (e.g., geomorphic features) is displayed within the graph (e.g., the line connecting the water surface elevation points can either be shown or not shown).

Upon opening, the data for the cross-section data set may be analyzed for parameters. The information may be shown in the General Characteristics Table that is embedded into the Chart Module. This general characteristics table may provide overall information including, but not limited to, channel width, maximum depth, cross-sectional area, width/depth ratio, wetted perimeter, and hydraulic radius. Values for these parameters may be calculated for the cross-section at the water surface elevation, the bankfull elevation, and/or other elevations.

A user may delineate and subdivide the Cross-Section into general sub-sections (e.g., left overbank, main channel, right overbank, etc.) and feature sub-sections (e.g., terrace, floodplain, overflow channel, etc.). This ability to subdivide the cross-section may enable precise hydraulic modeling and may aid in better understanding the composition and function of the riparian corridor. The system may enable control over creation of these critical subdivisions and customization to promote the better analysis in this analysis module and in other modules (e.g., Hydro Analysis Module).

A summary table may summarize the cross-sectional data and other important and related information. This summary may include the survey and elevation data along the cross-section, and/or tables for benchmarks, markers and images. These may aid in the analysis of the cross-section and may improve the cross-integration of data and information between modules.

Control features may allow for new data and segments to be created, defined, or changed.

A benefit may be that the cross-section data is approximately immediately available for use in the other primary analysis components/modules without further need for outside data processing or re-entry of the data.

The Cross-Section Analysis Module may allow the user to analyze the original Cross-Section data set and refine both the data set and the analysis. The system may work in concert with the accepted field techniques of watershed professionals use and accept, manipulate, and analyze cross-section data directly from field notes and incorporate the post-field work editing in a manner intuitively understood. The benefits of this industry specific orientation may include quicker input, more intuitive processing and analysis of all cross-section data and there may be cost savings for the user associated with this improved efficiency. Additionally, the improved efficiency may allow a user to be more productive.

The data types (e.g., surveyed, interpolated, or user-created) may be differentiated. The module may include built-in safeguards to protect data integrity and to aid in the verification of cross-sectional data.

Collectively, the user may be allowed the ability to edit, modify and supplement the Cross-Section data for a watershed assessment and/or characterization. Cross-component integration may include the Cross-Section data. For example, information from this module may be available in the Hydro Analysis Module. Sub-sections created in the module may be automatically imported into the Hydro Analysis Module and each can be assigned its own Manning's n value(s). Annotations and cross-references may be made between the individual components (e.g., the location of a turning point or flow measurement may be referenced within the cross-section component).

Results of the Cross-Section analysis may be available in tabular format or in graphical charts and plots. These results may be further customized by the user. Additional parameter fields may be added to the tables and adding additional chart types may be added and/or the charts can be inverted. The user may control how they develop and how they display their Cross-Section analysis and modeling results. There may be already pre-built templates in the Reports Module so the user can easily output professional reports for all their Cross-Section analysis.

The Cross-Section Analysis Module may include User Interface Components 702. The User Interface Components 702 may include a Header Component 712, a Chart Component 704, Sub-Sections Table Component 706, Survey Point Table Component 708, Benchmarks Table Component 710, Survey Markers Table 716, XS Images Component 718, and/or Menu Component 714.

The Header Component 712 may render critical file information and metadata regarding the Reach, the Survey, and the specific Cross-Section. For a complete watershed analysis, the number of individual associated files may become very extensive and clearly identifying the currently open files and their hierarchical relationship may allow user to easily understand the contextual setting of their cross-section. The Header Component 712 may provide functionality to create, edit, open or delete Longitudinal Profile files. This component may provide access to the primary navigation menu for switching between modules.

The Chart Component 704 may provide a graphical display and may automatically update as the Cross-Section file is created and Survey Points are added, edited, or deleted. The graphical display may provide a visual summary of the components and overview of the Cross-Section data set. The graphical display may include both stage height and elevation on the vertical axis so that the data being shown is tied to its actual elevation (e.g., relative to the reference elevation datum) and to the stage height. The system may use standard nomenclature and calculations to determine stage heights (e.g., calculated as the vertical distance upwards from the channel's thalweg). The scale on the vertical axis may automatically change and re-size to show the pertinent data in the cross-section file. The graphical display may include distance on the horizontal axis, enabling the data being shown to tie to its actual distance or location along the length of the cross-section. In the graphical display, lines may connect similar data points. For example, the ground elevation points may be connected by a single line. The water surface elevation points may be connected by a single line. And, the other key features, bankfull and terrace elevations, may each have their own lines. Each of these lines may be color-coded and easily distinguishable from the others to aid the user.

The graphical display may show Benchmarks or Survey Markers associated with the Cross-Section. If present in the Cross-Section file, these may be located within the graphical display at the correct elevation and horizontal distance. Showing benchmark locations on the display may allow the user to better determine where there are existing elevation control points within the cross-section. Showing the Survey Marker locations may aid in the cross-integration of data. For example, a marker might show the location of a flow measurement and show its location within the cross-section. Other examples of using a marker to locate important associated information within the cross-section may be locating a pebble count marker, or fish habitat assessment site, or vegetation assessment, or the boundaries of an associated wetland. This may enable a user to create a very specific three-dimensional interpretation (e.g., x,y, and z) for a sub-area within the cross-section. The locations of Images associated with the Cross Section may also be displayed in the Chart Component.

There may be a legend within the graphical display that clearly associates or sets forth line color with the type of data (e.g., ground elevation, water surface, bankfull or terrace, etc. A default setting may be for all data types to be pre-selected and displayed. The legend may be interactive and the user can select what types (thalweg, water surface, bankfull or terrace) of data to display or not display. This may result in the user being able to refine the displayed information to exactly match their analysis needs at the moment and easily change this as their needs or desires change. For example, they may be initially interested in low-flow conditions and not want to see the bankfull or terrace elevation lines which they would de-select for display (e.g., turn it off). Then, after completing the low-flow analysis, they may be next interested in a detailed look at higher discharges (e.g., bankfull or even flood flows). They may elect to display the bankfull line by selecting it (e.g., turn it on) and not display the water surface elevation line by de-selecting it (e.g., turn it off). The legend may also have selectable buttons for the Benchmarks, Survey Markers, and Images. A default setting may be for these data points to be displayed within the Cross-Section at their appropriate elevation and distance. Because they are selectable, the user may elect to not display this information.

Over the cross-section, there may be a significant difference in elevation. The system may optimize the display of the data to allow for the clear distinction of features and individual data points. To accomplish this, the scale of the vertical axis may be significantly different from the horizontal scale and this results in a display that has vertical exaggeration. The system may dynamically calculate and prominently show the vertical exaggeration in the graphical display. As the display changes either through a change in data or if the user changes the view (e.g., zooms into a portion of the profile) the vertical exaggeration may be re-calculated and shown so that the displayed value reflects the current view.

Initially, the system shows the Cross-Section in the graphical display and it may automatically optimize both the vertical and horizontal scales to accomplish this while also providing for the largest possible vertical scale so that the individual data points are as distinct as possible. A user may want to focus their interest on a specific portion of the cross-section or may need to increase the scale (e.g., enlarge the graph) to more clearly refine the view. For example, if the cross-section is extremely long in length, the user may need to view it in smaller portions for analysis (e.g., enlarge it). The system may allow for this by providing controls to change the scale and shrink or enlarge the display (e.g., zoom in and zoom out). Only a portion of the total Cross-Section may be shown. The system may allow for this enlarged view to be moved to the left and right allowing the desired zoom level to be maintained while the user may change the portion of the Cross-Section that is being shown. In these types of cases, the vertical exaggeration may be different from the original display and the system may calculate and display a new vertical exaggeration value with each change of the graphical display. The result may be that no matter how the user edits the data or changes the view by zooming in or out, or panning left or right, the user may constantly have an accurate value of the vertical exaggeration of the current graphical display.

Another feature of the Chart Component may be a display showing the known or calculated distance and elevation at any point in the Cross Section. Elevation and distance information for points between Survey Points may be calculated automatically.

A cross-section may be comprised of a majority of interpolated elevations based upon a limited number of known elevations. Manually calculating elevations for a desired location is an extremely time consuming and tedious process. Visually approximating elevations is not usually a means of deriving good or accurate analytical results. The system's ability to approximately immediately make available the pertinent information at a distance along the cross-section, may reduce the time required to adequately analyze the Cross-Section data and improve accuracy. Another benefit may be that this allows the user to more quickly customize and refine the Cross-Section data set if they need to insert a Survey Point or break it into a Sub-section or create a new Sub-section boundary. Without this feature, these may be extremely cumbersome and difficult issues.

Collectively, the Chart Component may be a visual summary of all the Cross-Section data and information in the individual file. This may provide a user with a unique overview of the Cross-Section data. The graphical nature may provide an overview enable understanding of how the field derived elevations for each data type (e.g., ground elevation, water surface elevation, bankfull elevation, and the terrace elevation) inter-relate to each other at each point throughout and along the cross-section. It also may provide a quick way to ascertain between an actual surveyed elevation and an interpolated or calculated elevations between survey-derived elevations. The graphical component may define areas that might need or require supplemental elevation data for refinement and may be used to define further data collection efforts. The graphical display may allow a user to determine where there might be issues with the survey data set and how best to correct any issues or problems. The benefit of this component may be a better or more-refined analysis and savings in time, better accuracy, and/or improved efficiency.

An Embedded General Characteristics Table may be embedded within the Chart Component of the Cross-Section Analysis Module. This table may provide summary information for review. A default setting may be for this table to analyze and provide the channel width, maximum depth, cross-sectional area, width/depth ratio, wetted perimeter and the hydraulic radius for the cross-section at the bankfull elevation and at the water surface elevation. A user may change this in the preferences settings to add other data types (e.g., terrace elevations). This summary and/or overview may summarize characteristics or attributes of the cross-section. The general characteristics table may be another place where the system cross-integrates data between modules by automatically making these overall parameters available to other modules. For example, the overall parameters (e.g., width/depth ratio) may be automatically available to the Rosgen Classification Module to aid in the reach classification.

The Sub-Sections Table Component 706 may enable the user to sub-divide the Cross-Section into more useful sections and enable association of a Sub-Section with either a general characteristic or a specific feature. This component may be a table that displays the general sub-section, the feature sub-section, position (distance) and other information for each Sub-Section within the Cross-Section. The system may allow the user to have control of this process and how to sub-divide the Cross-Section data and delineate general sub-sections and feature sub-sections.

The general sub-section may allow the user to assign a general location such as left overbank, main channel, and right overbank. The feature sub-section may allow the user to select what feature type, if any, they attribute to this Sub-Section. For instance, terrace, terrace slope, floodplain, bar, steep bank, overflow channel, and secondary channel may be attributed. The position field may show the start and ending distances/positions (distance along the cross-section) for the Sub-Section.

The user selects an existing Sub-Section from within the Sub-Sections Table Component. In response, the Sub-Section may be highlighted in the Sub-Sections Table Component. The selected feature Sub-Section may be highlighted in the Chart Component to make a visual connection to and show the Sub-Section in the graph of the cross-section. The individual Survey Points within that Sub-Section may be highlighted in the Survey Points Table Component. The net effect of all of these may be a clear visual connection between the Sub-Section, the graph of the Cross-Section, and what specific individual data points are found within the Sub-Section. This visual connection may help the user understand the sub-division and how they were derived with an intuitive connection between data points and elevations within the Sub-Section, its boundaries or delineators, and the graph of the Cross-Section.

The Survey Point Table Component 708 may include an interface to the Cross-Section data and may reference the underlying and constituent data that comprise the Cross-Section (which may exclude the subdivisions which are found in the Sub-Section Table Component). As with other components, the system may allow this component to interact with other components (e.g., the Chart Component and Sub-Section Table Component) to enable analysis and editing tools for the Cross-Sections. Collectively, the main components of the Cross Section Analysis Module may provide a total picture of the Cross-Section data and related information that is associated or referenced. The individual data points summary table component may aid describing the Cross-Section and its analysis.

The Survey Points Table Component may include detailed information and elevations (data) associated with a specific point of the Cross-Section. Within this unit, each data point or distance within the cross-section may reference the indicator, position/distance, specific elevation, stage height, the instrument height, site characterization, and an area for notes for that data set. Upon opening, this unit may be automatically populated with the processed Survey information for the Cross-Section. Users may select the geomorphic indicator for a Survey Point, such as left terrace, left bankfull, left water's edge, thalweg, right water's edge, right bankfull, and right terrace. The position may be the distance along the cross-section. In this table, elevations may be automatically imported and provided for each data point. The stage height may be also calculated and provided. The instrument height may be shown for each data point to enable understanding and retracing of the source of their elevation data. This may aid investigation or explaining an anomaly if the user sees something in the Cross-Section visually that seems incorrect. The user may specify the site conditions (e.g., Grass, Short or Grass, Medium). The table may also include a notes field that the user may fill in with a brief description or other information associated with a specific station along the cross-section.

The Survey data set may actually have two values for a feature. An example of this may be for the water surface elevations, the bankfull elevations and the terrace elevations which each have the potential for there to be two distinct elevations (left and right). In cases where the data set includes two elevations for a feature, the system may utilize and display the elevation for both in the individual data points table. A measurement with larger specified confidence may be indicated in the Chart Component and may be used in analytical calculations (e.g., found in the general characteristics table). In cases where there are two elevations for a feature and neither has been designated as the confident measurement, then the system may use both elevations, creating a connecting line that is not perfectly horizontal and calculations may be based using the average of both elevations.

New Survey Points may be added to Cross-Section from within this unit. These may be user-specified and kept distinct from the other two data types. The source of data and elevations may be kept distinct to show the data and its source. The Survey Points Table Component may be an excellent example of this being applied and carried forward from the Survey Module. In the Survey Points Table within the Cross-Section Module, the display (font and color) for elevation may be coded to indicate its source. As an example, elevations that are derived from the survey may be shown in black, elevations that the system interpolated or created may be shown in yellow, and elevations that the user created or added to the file may be shown in black italics. This may be standardized throughout the system so that the user understands the source of the elevation data.

The Benchmarks Table Component 710 may display Benchmarks that are found within the Cross-Section data set. This list may be automatically updated as Benchmarks are created (added), edited, or deleted and associated with the Cross-Section. In this unit's table, the label or name, position, elevation, identifying note and other information may be displayed for each Benchmark. If the user selects a particular Benchmark, then the displayed information may be highlighted within the table and the Benchmark may be highlighted in the Chart Component to make a visual connection between the Benchmark data and its position on the graph of the Cross-Section. This visual connection may enable understanding of Benchmarks and how they relate both positionally and with elevation to the Cross-Section. This may allow for an intuitive connection between the Cross-Section and the nearest primary elevation controls.

The Survey Markers Table 716 may enable association of unrelated information or data with a specific location along the Cross-Section. For example, it may be noted where pebble count substrate characterizations were collected, or where a flow measurement was performed, etc. For reference and cross-integration, the system may allow for the storage of this information as Survey Markers within a Cross-Section data set.

The Survey Markers Table Component 716 may display markers that have been associated with the Cross-Section data set. This list may be automatically updated as markers are created (added), edited, or deleted and associated with the Cross-Section. In this unit's table, the label (e.g., name), position or distance, identifying note and other information may be displayed for each Survey Marker. If the user selects a particular marker, then the displayed information may be highlighted within the table and the Survey Marker may be highlighted in the Chart Component to make a visual connection between the marker data and its position on the graph of the Cross-Section. This visual connection may aid understanding of the markers and how they relate positionally to their Cross-Section. This may enable an intuitive connection between the Cross-Section and the specific Survey Marker.

The XS Images Component 718 may allow the user to associate Images within the Cross-Section file and with a specific location along the Cross-Section. Uploading of images may be also completed within a different major module (e.g., the Images Module). Images uploaded that are associated with the Cross-Section may be available in this unit. A user may refer to a picture when working within their Cross-Section and receive an indication of the location of the picture.

The Images Component may display images that have been associated with the Cross-Section data set. This list may be automatically updated as Images are created (added), edited, or deleted and associated with the Cross-Section. If the user selects a particular Image, then the image indicator may be highlighted in the Chart Component to make a visual connection between the Image and its position on the graph of the Cross-Section. This visual connection may aid the user understand the Images and how they relate positionally to their Cross-Section. This may enable an intuitive connection between the Cross-Section and the specific Image. A benefit to this may be to aid the user during subdividing the cross-section into Sub-Sections.

The Menu Component 714 may include several options that allow for the manipulation of the Cross-Section data. There may be controls for the following: merge Sub-Sections, add a Survey Point, split Sub-Sections, add a Survey Marker, save, and save as. Each of these action controls may serve a specific purpose.

The “merge Sub-Sections” option may enable two segments to be joined together. The “split Sub-Sections” option may enable a Sub-Section to be split into two different Sub-Sections at a specified point. The “add a Survey Point” option may enable creating a new user specified Survey Point within the Cross-Section. The “add a Survey Marker” option may enable the creation of or adding a Survey Marker to the Cross-Section data set. The save button may be used when a Cross-Section data set has been modified and the user wants to save the current data. Finally, there is a save as button that may enable the user to duplicate the Cross-Section file with a new name (e.g., create a clone of the current data set).

The cross-section analysis module may include Implementation Services 802. The Implementation Services 802 may include XS User Interface Service 804, XS Data Store Service 808, XS Data Service 806 and XS Controller Service 810.

The XS User Interface Service 804 may enable communication between the user interface components. This service may act as an intermediary between components, so that messages pertaining to specific user actions within one component can be broadcast to other components that require that information. Thus, a component may respond to user actions that take place in another component.

The XS Data Store Service 808 may provide a local, in-memory representation of the currently open Cross-Section file. This representation may be updated based on user actions, so that other modules within the application are all synchronized to the current state of the Cross-Section file.

The XS Data Service 806 may provide an interface with the Server Application for purposes of storing and retrieving Cross-Section file data from the remote database. Cross-Section file data requests to the Server Application and responses from the Server Application may be routed through this service.

The XS Controller Service 810 may provide common methods for other Components and Services within the Cross-Section Analysis Module.

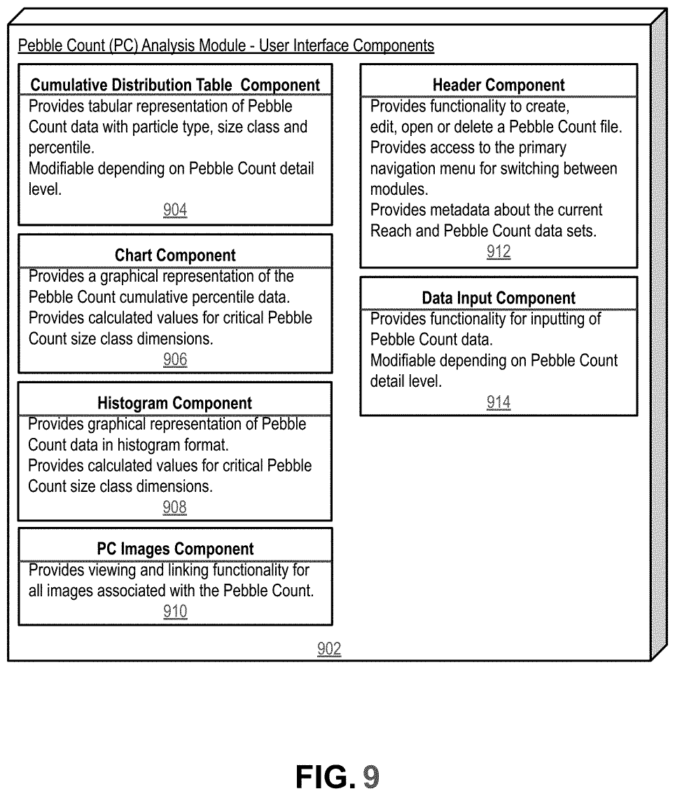

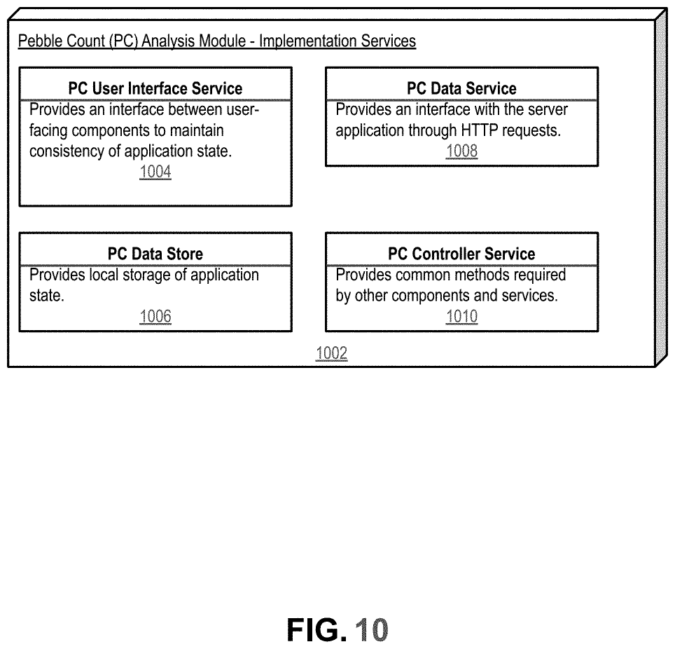

FIGS. 9-10 show an architecture diagram illustrating a pebble count analysis module. The Pebble Count Analysis Module may enable analysis, graphing, and to manipulate/edit/supplement the channel and substrate characterization data. This may involve processing of field data collected using a form or variation of the Wolman pebble count procedure. An alternative technique may involve collecting substrate samples and then performing a sieve analysis and distribution of substrate by size as a function of weight. The system may handle the process from raw field data to a final analysis and substrate characterization. This may include input of the field data, processing, analysis, and graphing. This module may allow for the characterization of the substrate.

The system may be configured to analyze the pebble count or substrate data, allow the user to interact, input, and refine the data, and to develop a representative summary of the analysis in both tabular and graphical formats.

This module may include several components: Data Input, Cumulative Distribution Table, Chart Component and Histogram Component and Images Component. The user may input their field data (e.g., Wolman pebble count data) into the Data Input Component, which enables pebble count analysis. There may be several potential options for the differentiation of size classes (e.g., there is not a single size class system for the breakdown of substrate data). The system may allow the user to choose from common, industry accepted size class systems. The system may enable selection of a system from one of pre-set size class systems and entry of data for processing and analysis. Once the proper size class system has been selected, data entry may occur. The system's ability to accept standard size classifications systems may allow the user to process their substrate data regardless of the field methods used and provide a refined analysis that is also available in other modules (e.g., Hydro Analysis Module).

With field data properly input and saved, the system may automatically perform analysis. The results may be found within the Cumulative Distribution Table Component as a tabular summary and in the Chart Component and Histogram Component as a graphical display. The Cumulative Distribution Table Component may be formatted to show the information used in the distribution calculations as well as presenting the analytical results. The size classifications set forth or used for particle size class delineation in this table may be matched and/or identical to one specified when the pebble count file received the input data.

The Chart Component 906 and Histogram Component 908 may have an embedded summary analysis table that shows size classes based on percentage of occurrence. Substrate characterization may include interpreting or predicting the size of a particle for specific percentages of occurrence in the sampling. The system may determine the predicted size of a particle associated with specific critical percentages (e.g., 15%, 35%, 50%, 84%, and 95%). For example, the system's statistical analysis may show that the d95 is equal to 140.28 mm which indicates that 95% of the sample set has an intermediate axis length of less than 140.28 mm. The system may automatically make these calculations for each of the standard percentages and present this information in the summary analysis table. In addition to the tabular summary, the graphical display may render both horizontal and vertical lines for each of the percent values where they intersect the sample's distribution plot. This may provide a visual connection between the sample data, interpretation, and the analysis table.

One benefit may be that the pebble count data is immediately available for use in the other primary analysis components/modules without the need for outside data processing or re-entry of the data.

The Pebble Count Analysis Module may allow the user to analyze the original substrate field data using a size classification system and provide a summary analysis. The system may work in concert with the accepted field techniques watershed professionals use. It may accept, manipulate, and analyze substrate composition data directly from field notes and incorporate post-field work editing and analysis. A benefit of this industry-specific orientation may include quicker input, processing and analysis of substrate composition data. There may be cost savings associated with this improved efficiency.

There may be cross-component integration of the pebble count data and analysis. For example, particle size information developed within this module may be available in the Hydro Analysis Module. This information may be a component to some of the hydraulic computation equations and the user will not have to re-enter the information. Also, a common equation used in hydraulic calculations may be based on the Manning's n equation where there is a direct connection between the substrate size and the channel's roughness. Having the substrate information available may speed up modeling using this equation as well as increase the accuracy of any models.

Results of the Pebble Count analysis may be available in tabular format or in graphical charts and plots. These results may be further customized by the user. Additional parameter fields may be added to the tables and adding additional chart types may be added and/or the charts can be inverted. The user may control how they develop and how they display their Pebble Count analysis and modeling results. There may be already pre-built templates in the Reports Module so the user can easily output professional reports for all their Pebble Count analysis.

The Pebble Count Analysis Module may include User Interface Components 902. User Interface Components 902 may include a Header Component 912, Data Input Component 914, Cumulative Distribution Table Component 904, Chart Component 906 and Histogram Component 908.

The Header Component 912 may display critical file information and metadata regarding the Reach and the specific Pebble Count file. For a watershed analysis, the number of individual associated files may become extensive. Clearly identifying the currently open files and their hierarchical relationship may allow a user to understand the contextual setting of their pebble count. The Header Component may provide functionality to create, edit, open or delete Pebble Count files. This component also provides access to the primary navigation menu for switching between modules.

The Data Input Component 914 may provide sections: general information for the pebble count data and the specific pebble count data. The general information section may include inputs for the Label (name) for the Pebble Count, the date the data was collected, the method used in collecting the data (e.g., riffle only), the detail level, a brief notes section, and then several fields for the collectors' initials.

The detail level menu may be where the user specifies a size classification system for use. The system may include predominant systems available for selection from the menu while others can be added in the user's preferences settings. A default setting may be for a general of size classification systems or a “basic” level of detail. Other choices may be progressively more refined in their size classifications. For example, in the “basic” detail level, cobble sized material (between 64 mm and 256 mm) may fall within a single category. But, in an expanded detail, this may be subdivided into two sub-categories or specifications: Small Cobble (64 mm to 128 mm) and Large Cobble (128 mm to 256 mm). In a more refined classification system, the “detailed” system, this may be even further subdivided into four sub-categories or specifications: Very Small Cobble (64 mm to 90 mm), Small Cobble (90 mm to 128 mm), Small Large Cobble (128 mm to 180 mm), and Large Cobble (180 mm to 256 mm). Depending upon the detail level selection, the appropriate data entry table (with the correct size classes displayed) may be provided for entry of the field data into the table. A user may edit their pebble count data using the same input form and dialogue box.

The Cumulative Distribution Table Component 904 may provide a tabular summary of a statistical analysis of the substrate data. The summary may be presented with the size classification system that the user selected when they input their field data. The Cumulative Distribution table may show the particle type (e.g., size classification), size range for each classification category, the number of occurrences in the data set, and a running cumulative percent value.

The Chart Component 906 may present the statistical cumulative distribution analysis. A chart of the statistical cumulative distribution analysis may present the substrate composition data on semi-log scale. The user may specify the size classes, that each size class has a data point, and a line connecting the individual data points which are also shown on the chart with a symbol. The connecting line may enable interpretation of results between actual data points. For example, the statistical percent of occurrence for a given particle size may be inferred. Also, the particle size may be interpreted for an occurrence. The user may be enabled to make any needed interpretation of the channel's composition and a substrate characterization is possible.

To help the users determine some of the critical parameters, the system automatically places indicators on the chart for percent occurrence values of 15%, 35%, 50%, 84%, and 95%. Horizontal lines for each percent occurrence may go across the chart to the point where they intersect the actual data line. Vertical lines from this intersection may go downwards to the horizontal scale. In combination, these lines may enable the user to make a visual connection between key percent occurrence values and the predicted particle size based upon the statistical analysis of their data set. This may enable them to make a visual connection between what is shown in the embedded summary analysis table and the actual data shown on the graph. There may be an embedded summary analysis table that provides parameters that are typically used or needed by watershed professionals.

The Histogram Component 908 may render a histogram of the statistical cumulative distribution analysis. The histogram of the statistical cumulative distribution analysis may present the substrate composition data as a bar chart histogram. The user may specify the size classes. Each size class may have a data point within the histogram chart. The system's histogram may be useful to the users and enable them to evaluate the distribution of particle sizes. For example, this histogram may enable better understanding of the substrate composition. A user may be able to answer questions about the data, such as, whether their data is evenly distributed, exhibits a single size-class that is significantly dominant, or if there is a bi-modal distribution. Information from the histogram may combine with the chart and enable a user to better interpret their pebble count data and provide a substrate characterization.

There may be an embedded summary analysis table that provides parameters that are typically used or needed by watershed professionals.

The Embedded Summary Analysis Table may be embedded within a graphical display of the pebble count data in both the Chart Component and the Histogram Component. This table may provide summary information for quick review. A default setting may be for this table to analyze and provide the statistically predicted particle size for critical percentage occurrences (e.g., 15%, 35%, 50%, 84%, and 95%). A user may alter this in their preferences settings to add other or delete these pre-set calculated values. This may be an excellent summary or overview of key characteristics or attributes of the channel's substrate. The Summary Analysis Table may be another place where the system cross-integrates data between modules by automatically making these overall parameters available to other modules. For example, the particle size associated with an 84% occurrence may be approximately immediately available use by the Hydro Analysis module (e.g., this is a value used in one of the optional hydraulic equations). Another example may be the particle size associated with the 50% occurrence is immediately available in the Rosgen Classification Module (e.g., a size value for determining a Level II Rosgen classification). The values predicted in the Summary Analysis Table may be used by the system to validate, verify, and cross-check user inputs to increase accuracy and improve the assessment.

The Pebble Count Analysis module may include Implementation Services 1002. Implementation Services 1002 may include a PC User Interface Service 1004, PC Data Store Service 1006, PC Data Service 1008 and/or PC Controller Service 1010. The PC User Interface Service 1004 may allow for communication between the user interface components. This service may act as an intermediary between components, so that messages pertaining to specific user actions within one component can be broadcast to other components that require that information. Thus, a component may respond to user actions that take place in another component.

The PC Data Store Service 1006 may provide a local, in-memory representation of the currently open Pebble Count file. This representation may be updated based on user actions, so that other modules within the application are all synchronized to the current state of the Pebble Count file.

The PC Data Service 1008 may provide an interface with the Server Application for purposes of storing and retrieving Pebble Count file data from the remote database. Pebble Count file data requests to the Server Application and responses from the Server Application may be routed through this service.

The PC Controller Service 1010 may provide common methods for other Components and Services within the Pebble Count Analysis Module.

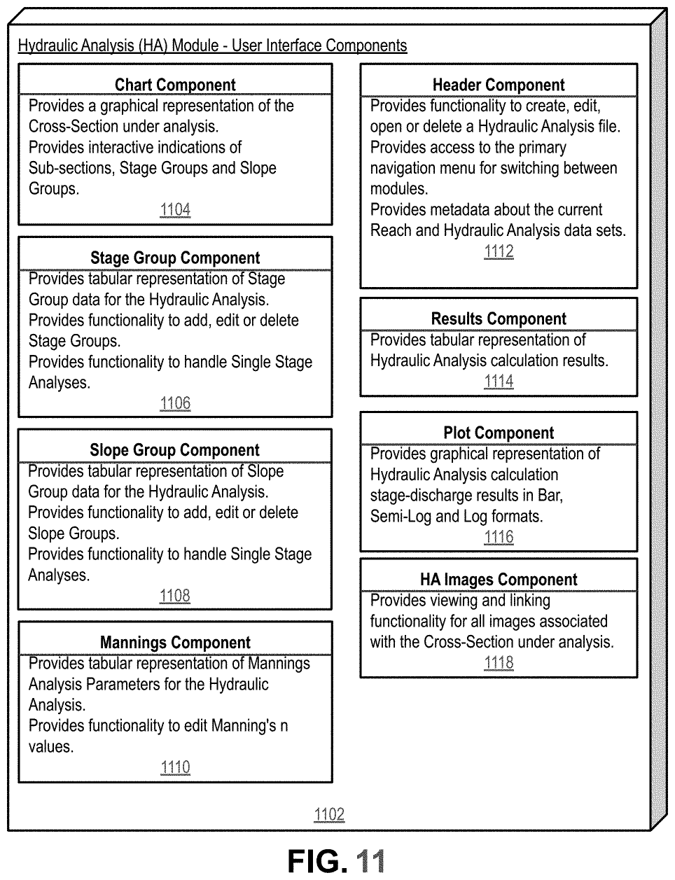

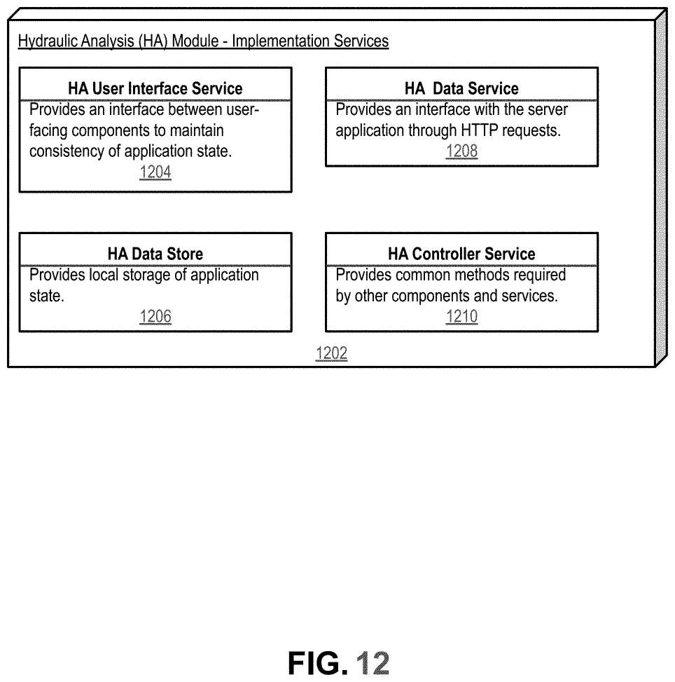

FIGS. 11-12 shows an architecture diagram illustrating a hydraulic analysis module. The Hydro Analysis Module may provide a user with an ability to create, analyze, graph, manipulate/edit/supplement, and calibrate a hydraulic model. The system may assist in this analysis and graphing. Natural systems, like river and stream systems, and/or man-made systems may be complex. Flow or discharge in an open channel system and/or closed channel system may vary with time, by the amount of water that a watershed produces and by the conditions within the study area. Creating an accurate model of flow conditions may be complex. The Hydro Analysis Module of the system may be robust and enable, with all its constituent components, creating a complex model to predict and adapt to the complexity of the open channel systems (e.g., river, stream, ditch, irrigation conveyances, etc.) and/or closed channel systems (e.g., pipe, culvert, etc. that may be pressurized or non-pressurized).

The system may allow existing cross-sections that were processed in the Survey Module and then analyzed and graphed in the Cross-Section Analysis and Graphing module to be the initial foundation for the hydrologic analysis. Compared with other modeling systems where there may be a lack of ability to process cross-sections from survey data or to previously analyze a cross-section, there may be no need to re-enter a cross-section's data or re-create it in this system. The data already may exist inside the Reach file and it is available with a simple selection from a menu. The cross-sectional information that is being used in this model may be already linked to the reach's reference elevation datum and the elevations and calculations within the Hydro Analysis Module may be directly relatable to elevational information in all the other modules.

Cross-sections may be divided into distinct sub-sections. These sub-sections may be further sub-divided into sub-groups, allowing the user to develop a more complex model to adapt to the complexity of and model the natural system they are characterizing. The user may delineate ineffective flow or conveyance exclusion areas to prevent the system from using this area for flow calculations. By allowing these areas to be user-specified by combining horizontal, vertical, and sloped boundary lines, the system may provide a unique manner of customization and model refinement.

The system may support standard equations used in hydraulic modeling, including Manning's n equation, Jarrett's equation, Thorne and Zevenbergen's equation, and/or Nelson, et al equation or other equations. A user can may create a single-stage analysis where they predict the discharge or flow at single stage height or water surface elevation (e.g., for a specific date or time). The user may create a multistage analysis, making discharge predictions over a range of stage heights and varied water surface elevations (e.g., for the varied conditions over a length of time).

Results of the hydro analysis may be available in tabular format or in graphical charts and plots. These results may be further customized by the user. Additional parameter fields may be added to the tables and adding additional chart types may be added and/or the charts can be inverted. The user may control how they develop and how they display their hydrologic analysis and modeling results. There may be already pre-built templates in the Reports Module so the user can easily output professional reports for all their hydrologic analysis.

Detailed cross-sectional survey data may have already been processed and the cross-section's data and analysis may be immediately available within this Module while still maintaining the same reference elevation datum that exists for the data in the reach file. Images associated with the selected Cross-Section in the Images Module may be available based on a new Hydro Analysis starting and can may be referred to at any point in the model's progression or development. Slope values that the user enters may be checked with slope values that were calculated in the Longitudinal Profile Analysis and Graphing Module to insure accuracy and warnings of potential problems. User input Manning's n values may be compared to a range of predicted values based on pebble count data from the Pebble Count Module. A user may calibrate their hydraulic model by using their flow measurements and data from the Flow Measurement Module. Other examples are possible, as these mentioned are just a few examples of the cross-integration of data aiding the user by simplifying tasks and eliminating/reducing data input, cross-checking inputs against other data sources, and providing warnings of potential issues and possible methods to resolve concerns.

The Hydraulic Analysis Module may include User Interface Components 1102. The User Interface Components 1102 may include a Header Component 1112, Chart Component 1104, Stage Group Component 1106, Slope Group Component 1108, Manning's n Component 1110, HA Images Component 1118, Results Component 1114 and Plot Component 1116. The Header Component 1112 may display file information regarding the reach, the survey, and the specific hydraulic analysis. Reach information displayed may include the reach name, region, and level I Rosgen classification. Identifying information of the specific hydrologic analysis that the user is currently working within may include the analysis' name, dates of processing, the cross-section name that is being used as the base, and the hydrologic equation being utilized. For a watershed analysis, the number of individual associated files may become extensive and clearly identifying the currently open files and their hierarchical relationship may allow a user to understand the contextual setting of their hydrologic analysis and how it relates to other data components and files.

The Header Component may use file controls for the Hydro Analysis files located in a menu on the title bar. Working within the overall individual reach file, these controls may enable the user to open a specific Hydro Analysis file, to edit an individual existing Hydro Analysis file, to create a new Hydro Analysis file, or to delete a Hydro Analysis file. To create a new Hydro Analysis, the user may be provided the option to enter a label, date, the name of the analyst and any pertinent notes. The user may select from a list of all available Cross-Sections within the Reach file to use as the base for the hydrologic analysis. The specification may include choosing a hydraulic equation or model to use for this analysis. The default choices for this menu may include Manning's n equation and Jarrett's equation. Other equations (e.g., Thorne and Zevenbergen's equation and Nelson, et al) may be accessed in the user preference section and added to the menu. The Header Component may provide access to a navigation menu that allows for the user to move from one analysis module to another.

The Chart Component 1104 may be an abbreviated display of the cross-section that has been selected for hydraulic analysis. A portion of the cross-section that is part of the hydro analysis may be shown. The displayed cross-section may show stage height on the vertical axis and position/location on the horizontal axis and display the appropriate data from the cross-section. The vertical exaggeration of the current display may help the user visually understand the display. As the user makes specifications regarding the stage height and sub-sections, the display may adapt and change to reflect these changes. The chart component may have a button to allow the chart to be enlarged or shrunk. The calculated vertical exaggeration may update and change as the chart is enlarged or shrunk.

Accurate hydraulic models may become complex with multiple variables changing both vertically and horizontally. Being able to visually see and correlate each of the parameters within and on the cross-section display may increase efficiency and improves quality of analysis and models.

The Stage Group Component 1106 may allow the user control over the stage heights that will be analyzed. The user may elect a single-stage hydraulic analysis or select and/or specify a range of stage heights. The system may include built-in safeguards to help the user specify only stage heights or elevations that are reasonable or possible given the cross-section they are analyzing. For example, if the cross-section has a thalweg elevation of 4,216 feet, the system may warn them if they specify a stage elevation of 62 feet (e.g., physically not possible).

The various components within the Hydro Analysis Module may be designed to be interactive and respond to changes in other components. For example, the Chart Component may change as the user is working within other components. Changes within the chart component may aid the user while they are working in the other component(s). Within the Stage Group Component, the user's selections may result in in changes to the chart being displayed. For example, if the user has selected a single-stage hydraulic analysis, the chart may show a line across the cross-section coinciding with the stage height or elevation that is specified by the user. If they change the stage height or elevation, the line may move upwards or downwards on the cross-section. This may be a visual connection that helps the user specify the exactly correct or desired stage height to analyze. As another example, if the user is developing a multi-stage hydraulic analysis, the chart may highlight a range of stage-heights within the cross-section coinciding with the upper and lower boundaries that user specifies. If multiple groups, the group they are currently developing or editing may be highlighted in the cross-section display. This may be a visual aid and connection to help the user develop the model and avoid unintended mistakes or specifications.

If the user selects a single-stage hydraulic analysis option, they may enter either the stage height or the elevation to analyze. The system may automatically calculate the corresponding value depending on the user's entry. This may eliminate a need for the user to enter both the stage height and the elevation (e.g., saving time and effort). If they enter the stage height, the system may calculate the corresponding elevation. If they enter the elevation, the system may automatically calculate the corresponding stage height. The user may have already provided the stage height information required to perform a single-stage height hydro analysis. They may save the stage parameters before moving to the next desired component.

If the user selects a multi-stage hydraulic analysis option, they may have control to develop a complex range of stage heights for analysis. For example, they may elect to have a single group of stage heights evenly distributed. They may name or label the group and specify either the stage height or elevation for both the upper and lower boundaries of the analysis. Similar to the single-stage analysis, the system may automatically calculate the corresponding value depending on the user's entry. This may eliminate a need for the user to enter both the stage height and the elevation (e.g., saving time and effort). If they enter the stage height for the lower boundary of the analysis, the system may calculate the corresponding elevation for the lower boundary. If they enter the lower boundary's elevation, the system may automatically calculate the corresponding stage height. This may be the case for the upper boundary being specified.

The next fields may specify how the established range of stage heights will be subdivided. The user may specify the number of increments to be used in the subdivision and/or the amount of incremental change in stage between each stage calculation. The system may automatically calculate the corresponding value depending on the user's entry. This may eliminate entry of both the incremental change and number of increments (e.g., saving time and effort). For example, if they specify the number of increments, the system may calculate the corresponding incremental stage height variation value. If they enter the incremental value, the system may automatically calculate the resulting corresponding number of increments.

These fields may be editable. This enables the user to quickly adjust any of the values to develop and specifically tailor the stage heights being analyzed. The user may have provided the stage height information required to perform a single group multi-stage height hydro analysis. They may save the stage parameters before moving to the next desired component.

If the user would like to develop an additional group of stage heights (e.g., develop a multi-stage model with multiple groups), they may add a new group and repeat the process set forth above. The level of detail may need to be varied over a wide range of stage heights. For example, a user may look at low flow conditions and desire very small incremental changes over a relatively narrow range of stage heights (e.g., 0.10′ increments between 0.5′ and 1.0′ producing hydraulic calculations at 0.5′, 0.6′, 0.7′, 0.8′, 0.9′ and 1.0′). They may then need less precision, fewer calculations, at stage heights above this value. For example, they may then want to only perform calculations every 0.25′. In the past, this may have been accomplished by creating multiple independent hydraulic models. With the system, the user may specify a second group and the model will be created Using the example above, the low flow portion may be specified in the first group (incremental stage variation of 0.1′) and the second group may have stage heights varying by an increment of 0.25′. This versatility in stage specification may be a significant improvement for a user and a part of the customization options that the Hydro Analysis Component provides.

When the user has finished creating and specifying stage groups, the fields for each group may be editable. This editing allows the user to adjust any of the values to develop and specifically tailor the stage heights being analyzed. At this point, the user may have provided the stage height information required to perform a multi-group, multi-stage height hydro analysis. These complex stage parameters may be saved.

The Slope Group Component 1108 may allow the user control over slopes used in the analysis. In real-life, the water surface slope may or may not vary and the system allows for both conditions. The user may specify a static or unchanging slope or a slope that is dynamic and changes as the stage height changes. Depending on the specifications, the system may interpolate a slope value for a stage height if one has not been specifically set by the user. Slopes values that are user-specified may be kept distinct from those that are interpolated. This may enable understanding of the source of their slope data throughout the Hydro Analysis Module.

The various components within the Hydro Analysis Module may be intentionally designed to be interactive and respond to changes in other components. For example, the Chart Component may change as the user is working within other components. In these situations, changes within the chart component may aid the user while they are working in the other component(s). User selections in the Slope Group Component may result in in changes to the chart being displayed. For example, if the user has selected a single-stage hydraulic analysis, the chart may show a line across the cross-section coinciding with the stage height or elevation that is specified by the user. If they change the stage height or elevation, the line may move upwards or downwards on the cross-section. As another example, if the user is developing a multi-stage hydraulic analysis that also contains multiple slope groupings, the chart may highlight the stage-heights for the slope grouping within the cross-section coinciding with the upper and lower boundaries that user specifies. If they have multiple groups, the group they are currently developing or editing may be highlighted in the cross-section display. This visual aid and connection may help the user develop the model and avoid unintended mistakes or specifications.

If the user elects to perform a single-stage hydraulic analysis, then they may have to specify a slope value for that analysis. The system may use built-in safeguards to help the user specify only slope values that are reasonable or possible. For example, the user cannot specify a negative slope value and will be warned if they try to do this. The system may compare slope values the user specifies to those that have been calculated within the Longitudinal Profile Analysis and Graphing Module and warn them if there is an inconsistency or a possible issue. As examples, if the maximum slope found within the entire longitudinal profile is 0.02 ft/ft, the system may warn them if they specify a slope value of 0.04. Or, if the shallowest slope calculated in the longitudinal profile is 0.01, they may be warned if they specify a slope value of 0.002. These warnings may be individually tailored and display the conflicting information and suggest a possible solution.

If the user has selected the single-stage hydraulic analysis option, they may have entered the desired stage height in the Stage Group Component and may specify the desired slope to use in the hydraulic analysis. Upon doing so, the user may have provided the slope information required to perform a single-stage height hydro analysis. They may save the slope parameters before moving to the next desired component. The user may have provided the slope information required to perform a single-stage height hydro analysis. They may save the slope parameters before moving to the next desired component.

If the user has selected the multi-stage hydraulic analysis option, they may have already specified a range of stage heights for this analysis (e.g., created the lower and upper stage boundaries). Regardless of whether they subdivided this range (stage) into a single group or multiple stage height groups, the user may specify a slope value or slope values over the range of stage heights. Like stage height grouping, they may create a slope group or groupings. Slope groupings may be independent of the stage group(s) or grouping(s) that the user may have created in the Stage Group Component. They may create a distinct single group of slope values over the range of stages (e.g., a slope values would be specified for the lower and upper stage boundaries). They may create multiple groups of slope values over specific subdivisions of the potential stages. For multiple groups of slope values, the lowermost group may be bounded at the bottom by the lower stage boundary and bounded at the top by some intermediate stage height that is less than the upper stage boundary. The next group may be bounded at the bottom by the upper stage height boundary of the first group and be bounded at the top by the maximum stage height (e.g., if there are only going to be two slope groups) or by another intermediate stage height (e.g., if there is going to be a third group). This subdivision or grouping process may be repeated, as needed, to create the desired number of slope groupings over the entire range of stage heights.

For a multi-stage analysis, the simple case may be if a single group of slope values is elected. In this case they may add a slope parameter group by clicking on the appropriate “Add” button. The group may appear in the table and some fields may be automatically pre-filled for the user. The user may change the name or label and specify or create a personalized name for this slope group. The system may automatically pre-fill the low stage and elevation fields to the correct stage and elevation values matching the lower boundary of the stage ranges that were specified in the Stage Group Component. The user may enter the low slope value for this stage height or elevation. The system may automatically set the high stage and elevation fields to the correct stage and elevation values matching the upper boundary of the stage ranges that were specified in the Stage Group Component. The user may enter a high slope value for this stage height or elevation. The system may interpolate, using an arithmetic linear regression, slope values for any stage heights between the low and high stage heights that are not specifically set forth. For a single group of slope values, the user may have provided the slope information required to perform a multi-stage height hydro analysis. They may have specified a low stage slope value and a high stage slope value and the system may, if necessary, interpolated any needed slopes between these two stage heights. The user may save the slope parameters before moving to the next desired component.

For a multi-stage analysis, a more complex case may be electing to have a multiple groups of slope values. They may add the first slope parameter group by clicking on the appropriate “Add” button. The group may appear in the table and some fields will be automatically pre-filled for the user. The user may change the name or label and specify or create a personalized name for this first slope group. The system may automatically pre-fill the low stage and elevation fields to the correct stage and elevation values matching the lower boundary of the stage ranges that were specified in the Stage Group Component. The user may enter this group's low slope value for this stage height or elevation. The user may edit the high stage and/or elevation field to the desired stage or elevation value to use for the upper boundary of this group. The system may automatically calculate the corresponding value depending on the user's entry, which eliminates the need for the user to enter both the stage height and the elevation (e.g., saving time and effort). If they enter the stage height, the system may calculate the corresponding elevation. If they enter the elevation, the system may automatically calculate the corresponding stage height. The system may warn them if they attempt to enter values in either of these fields that are outside the range of possible values or a stage height that was not created in the Stage Group Component. The user may enter this group's high slope value for this stage height or elevation. The system may interpolate, using an arithmetic linear regression, slope values in this first group for any stage heights between the low and high stage heights that are not specifically set forth.

Unlike a single-slope group analysis, the user may not save the slope parameters at this point. Instead, they may click the “Add” button and create a next group in a similar manner as used for the first group. The group may be given a name that the user can edit and customize. The system may determine that this is a second group and may automatically pre-fill fields. For example, the lower boundary fields of this group, including the values for low stage, low elevation, and low slope, may be automatically pre-filled to match the upper boundaries of the first group. In this way, the second group's low stage may be set to be equal to the first group's high stage, the second group's low elevation may be set to be equal to the first group's high elevation, and the second group's low slope may be set to be equal to the first group's high slope. This group's (the second slope group) may have stage and elevation fields pre-filled with the upper limit boundaries of the pre-specified stage range. The user may change the upper limits if their intent is to create a third slope grouping. The user may enter the desired high slope value for the second slope group.

At this point, if two groups of slope values are sufficient, the user may have provided the slope information required to perform a multi-stage height hydro analysis. They may have specified a low stage slope value and a high stage slope value for the first group. The system may have pre-filled the low slope value for the second group. They may have specified a high slope for the second group. The system may have, if necessary, interpolated any needed slopes between these boundaries. The user may save the groupings and slope parameters before moving to the next desired component. If they want to create additional groupings, they may hit the “Add” button and repeat this process.

When the user has finished creating and specifying all their desired slope groups, the fields for each group may be editable which allows the user to adjust any of the values to develop and tailor the stage heights being analyzed. The user may have provided the slope values required to perform a multi-slop group, multi-stage height hydro analysis. They may save these complex slope parameters before moving to a next component. Being able to have this versatility in both slope grouping and in slope value specification is a benefit and an improvement, which may be a part of the customization options that the Hydro Analysis Component provides.

The Manning's n Component 1110 may be available if the user has chosen to perform a hydraulic analysis using the Manning's n equation when they initially created the new Hydro Analysis. Other equations may generate a Manning's n value that is not dependent upon the user. For example, Jarrett's equation may use its own equation to develop a Manning's n number that is independent of the user. In this case, there may be no reason for the system to display this component.

The Manning's n Component may enable control over the n values used in the analysis. Even at the same stage height, n values may or may not vary as one moves across the cross-sectional transect. For example, the n value just above a densely vegetated floodplain may be much higher than the n value at the same height but within the main channel where flowing water is below. Also, the n value may vary as the stage changes. For example, the n value may be significantly affected by the vegetation on a floodplain (high n value) but this effect will decrease as the water level rises and is no longer impacted by the vegetation (lower n value). The system may allow varying the n values across the cross-section and vertically as the stage changes (e.g., for of the example scenarios). In fact, it may allow for the user to create hydraulic model where the n value changes both laterally and vertically for a complex hydraulic models.

The user may specify a static or unchanging n value or they may specify an n value that is dynamic and changes (laterally or vertically or in both directions). Depending on their specifications, the system may interpolate an n value for a stage height if one has not been specifically set forth by the user. Similar to the survey module and other components within the hydro analysis module, n values that are user-specified may be kept distinct from those that are interpolated so the user understands and sees the source of their n value data in the Hydro Analysis Module.

The user may be allowed to create sub-sections of a cross-section in the Cross-Section Analysis and Graphing Module. These sub-sections may be available herein for specification and are potentially used to subdivide the cross-section into lateral segments. The system may show these and allow the user to specify n-values for lateral segments if the specified stage heights allow for the conveyance of water within that segment for the prescribed range of stages. Any vertical groupings of stage height (e.g., as specified in the Stage Group Component) may be present in the Manning's n Component.

This variability in horizontal or lateral sub-sections coupled with the vertical groups and allowing the n value to vary in each sub-section and group coupled with the system interpreting n-values for un-specified stage heights may result in a high complexity (e.g., coding, calculating, and for the user inputs). The system may reduce the complexity for the user and may aid them with the n value inputs.

The n value input table may be pre-loaded with the sub-sections and groups pre-filled with the pertinent data that has already been specified (e.g., the lateral sub-section and group names, the low stage heights and elevations, and the high stage heights and elevations). The user may enter low and high manning's n values for each lateral sub-section and each vertical group. If the user does not want to change the manning's n value (e.g., it is static for that sub-section and group), they may enter the same n value for both the low stage and high stage fields. Each line in the table may be interactive with the Chart Component. When the user selects that line for input or editing, the area being specified may be highlighted in the chart. This may enable the user to visually understand what portion of the cross-section they are specifying or editing. Despite the complexity, the system may simplify the process by providing visual aids.

When the user has finished specifying both high and low n values for the horizontal sub-sections and vertical groups, the fields for each group may be editable. The editable fields enable the user to adjust the values to develop and specifically tailor the n values. The user may have provided the Manning's n values required to perform a hydrologic analysis and model. They may save these complex n-value parameters (e.g., by clicking the “Save Manning's Parameters” button) before moving to the next desired component. This versatility in both lateral and horizontal grouping and of n-value specification may be a significant improvement for hydraulic analysis.

The HA Images Component 1118 may enable image upload and association. The system may allow the user to associate images within the Cross-Section file and with a specific location along the cross-section. Uploading of images may be completed within a different major module (the Images Module). Any images uploaded that are associated with the cross-section being used for the hydrologic analysis may be available in this component of the Hydro Analysis Module. The benefit may be that the user can quickly refer to a picture when working within their hydrologic analysis.

The HA images component 1118 may provide a user with the ability to view any image associated with the cross-section that they are currently working within and analyzing. This component may include: a display of the images in a smaller list display and a larger viewer of a single display image. This list display of smaller images may be automatically updated as images are created (added), edited, or deleted and associated with the Cross-Section being used for the hydrologic analysis. The default image displayed in the larger viewer may be an assigned representative image for the Cross-Section being used in this analysis. If the user selects a different image thumbnail from the smaller image display list, then the selected image may fill the image viewer window and the image icon may become highlighted in the graphical display to make a visual connection between the image and its position on the graph of the cross-section. This visual connection may help the user understand the images and how they relate both positionally and with elevation to the cross-section. This may enable an intuitive connection between the cross-section and the specific image. One benefit may be aiding the user when they are subdividing the cross-section into sub-sections and determining roughness coefficients.

The Results Component 1114 may be a tabular interface for the user to the hydrologic analysis. If the user has made specifications in the pre-requisite components (e.g., the Stage Group, the Slope Group, and the Manning's n Value components), then the user may complete a hydraulic analysis by clicking on the “Run Analysis” button. When instructed, the system may perform hydraulic computations for each stage height for each lateral and horizontal group using the user-specified data, interpolated data, and calculated values. Once the calculations are complete, the system may fill the table with information and results of the hydrologic analysis. The table may use default parameters (e.g., as appropriate for the type of analysis that was performed) that are shown in the table. The user may specify additional parameters or values in the user preferences.

The first two columns in the table may be primary control/identifying columns that specify the elevation and stage height. The table may display the Slope, Area, Wetted Perimeter, n-value, velocity and calculated discharge for each lateral sub-section. The table may also render the total discharge or flow (sum of the calculated flow in all the individual lateral sub-sections) and the mean velocity. This may be repeated for each stage height that has been specified or requested by the user.

In simple hydraulic models with one sub-section and only a few stage heights, this may be visible on a standard screen. The system may include an “Expand” button that alters the table such that it fills the entire screen. This may benefit the user when the model contains multiple horizontal sub-sections or numerous stage heights. The system may allow for the user to scroll left and right and up and down if, for example, the final table will not fit within the viewable area of the screen display. When an analysis has been performed and the table is filled with parameters and calculated values, the system may maintain and display data integrity and visually differentiate between user-specified data, interpolated data points, and calculated values by changing fonts, colors and using other features (e.g., italics and cell color fill) for each data type.

The Plot Component 1116 may be a graphical output window that presents the results of the Hydro Analysis in standard graphical formats. With the user having made specifications in the pre-requisite components (e.g., the Stage Group, the Slope Group, and the Manning's n Value components), then the user may complete a hydraulic analysis by clicking on the “Run Analysis” button. The system may perform hydraulic computations for each stage height for each lateral and horizontal group using both the user-specified data, interpolated data, and calculated values. Once the calculations are complete, the system may fill the Plot Component and render it on a selected plot. This may be called a stage vs discharge graph. Default graphs (e.g., those which accommodate the most prevalent types and most common situations) may be a bar chart, a log-linear chart (e.g., sometimes called a semi-log chart/plot) or as a log-log chart/plot. To further accommodate specialized needs, the user may have access to other chart types and can also change which variables are plotted on which axis (e.g., they can invert the axis) in their user preferences.

The Hydraulic Analysis Module may include Implementation Services 1202. The Implementation Services 1202 may include HA User Interface Service 1204, HA Data Store Service 1206, HA Data Service 1208 and HA Controller Service 1210. The HA User Interface Service 1204 may enable communication between the user interface components. This service may act as an intermediary between components, so that messages pertaining to specific user actions within one component may be broadcast to other components that require that information. Thus, a component may respond to user actions that take place in another component.

The HA Data Store Service 1206 may provide a local, in-memory representation of the currently open Hydro Analysis file. This representation may be updated based on user actions, so that other modules within the application may be synchronized to the current state of the Hydro Analysis file.

The HA Data Service 1208 may provide an interface with the Server Application for purposes of storing and retrieving Hydro Analysis file data from the remote database. All Hydro Analysis file data requests to the Server Application and responses from the Server Application are routed through this service.

The HA Controller Service 1210 may provide common methods for other Components and Services within the Hydro Analysis Module.

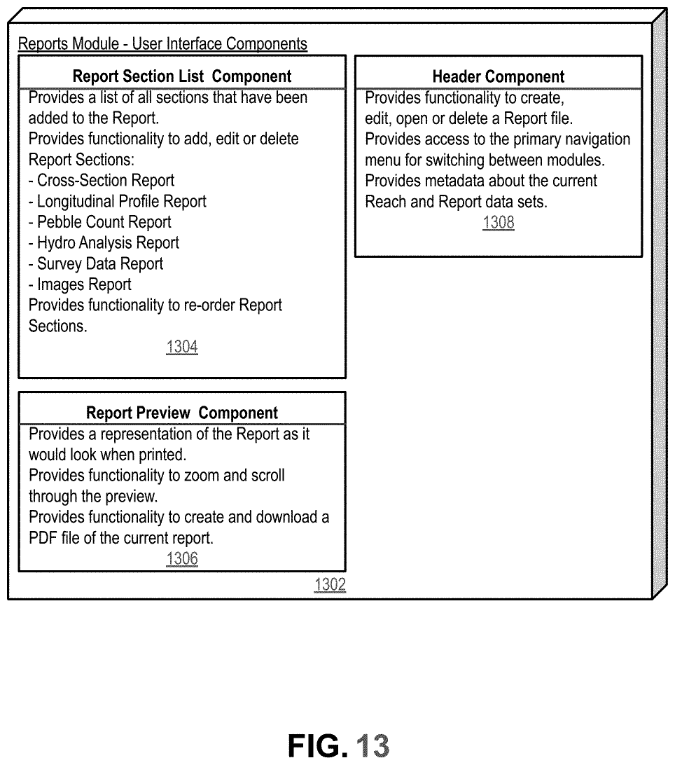

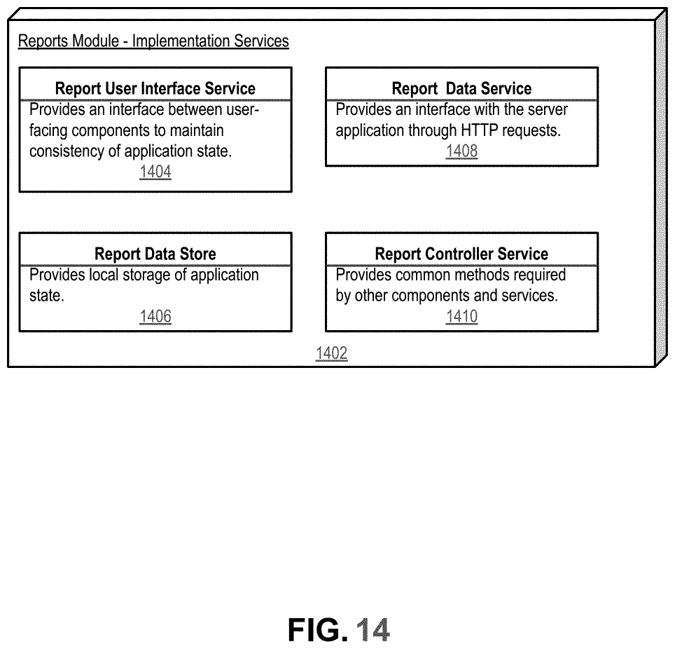

FIGS. 13-14 shows an architecture diagram illustrating a reports module. Reports that present data, information, analysis, graphs and images may be important aspects of watershed assessment. The system may include a Master Report generation engine. Report templates may include optional features and methods of customization for each of the individual data and analytical modules within the system (Individual Module Reports). For each module of the system, the pre-built templates may be designed for that module (e.g., the templates for the Cross-Section Module are different than the templates for the Pebble Count Module). For each of these templates, the system may automate the process or report construction. Reports may be generated with a user's organizational name, information, and logo. Customization options may be configured for each report type.

The system may produce single or multiple page reports (e.g., depending on the data and the user preferences). In many cases, the user may specify whether the report is oriented in portrait or landscape. Each report may include a title block of critical information included. If a report contains multiple pages, the pages may be numbered.

The system may enable the user to create a Master Report (a collection of individual component reports). In addition to customization options for individual module reports, the user may create the Master Report which may include individual report configuration and sequencing configuration. The system may automatically generate a title page, executive summary and a paginated table of contents listing its constituent reports. The pagination in the Master Report may be inclusive of and responsive to all individual reports. Reformatting, re-pagination, automated chart formatting may benefit from artificial intelligence to organize a display of reports.

The system may allow for the preview of reports and final reports to be available for download to the user's computer or storage device in a format that makes them printable.

The Reports module may comprise User Interface Components 1302. The User Interface Components 1302 may include Header Component 1308, Report Section List Component 1302, and Report Preview Component 1306.

The Header Component 1308 may display critical file information regarding the Reach and the specific Report. Reach information displayed may include reach name, region, and level I Rosgen classification. Identifying information for the specific report that the user is currently working within may include the report name (e.g., Master Report), report date, number of pages, and a list (e.g., at least partial listing) of specific individual reports (Individual Module Report(s)) found within the Master Report (e.g., total report document). For a watershed analysis, the number of individual associated files may become extensive. Identifying the currently open files and their hierarchical relationship may promote understanding of the contextual setting of this report and how it relates to other data components and files.

The Header Component may include file controls for the Master Report files located in a menu on the title bar. Working within the overall individual Reach file, these controls may enable the user to open a specific Master Report file, to edit an individual existing Master Report file, to create a new Master Report file, or to delete a Master Report file. To create a new Master Report, the user may select the “New Report” button and a dialogue box opens. In the “Add Report” dialogue box, the user may specify the Master Report's Label, date of creation, and the official Report Title. The label may be pre-filled with an editable name. The label may be a reference to the Master Report within the database and may be not printed on any of the actual reports. The next field may be the official title of the Master Report. The user may enter the title of the Master Report as it will appear in printed hardcopy. The final field may be a large, editable text field where the user can provide a written summary of the Reach and the contents of the Master Report. This written summary may be shown on the title page of the Master Report and printed hardcopy. It may act as a custom “Executive Summary” that explains the overall information for the Master Report. It may be used as an explanatory introduction or report overview. If satisfied with the specifications for the Master Report, the user may close the dialog box by selecting “Done.”

The Header Component may provide access to a navigation menu that allows for the user to move from one analysis module to another.

The Report Section List Component 1304 may aid the report generation engine. This component may list and provide a hierarchical organizing structure for the individual module reports within the Master Report file. It may be the interface that the user uses to add sections or Individual Module Reports to the Master Report file.

Information needed to initially configure the title page may be provided by the user when they first created the new Master Report file. The system may automatically generate the title page. The title page may be the first page shown in the Master Report preview in the preview display.

When the user first creates a Master Report, it may have no individual reports within the file. If the user wants to add a new section to the Master Report, they may select “Add Section.” A menu may appear that allows them to choose the general type of report (section) to add to the Master Report. Each major analysis module of the system may have built-in reports. The menu may include report choices such as: Cross-Section Report, Longitudinal Profile Report, Pebble Count Report, Hydro Analysis Report, Survey Data Report, Images Report, Rosgen Level II Classification Report, and Flow Measurement Report. The user may make a selection or choice and a dialog box tailored to the selected module report may open to customize and tailor the report. The customization and specification of each modules reports may be enabled. The user may add Report Sections until they have compiled selected sections into the Master Report. A complete Master Report may have a single section or it may include multiple reports from each of the major modules, including additional sections and sub-reports (as needed). The Master Report may be as simple or as complex as required.

The user may view and change the current sequential ordering of the Report Sections (e.g., they can move reports forwards or backwards within the total report simply by selecting and dragging them to the desired location). The user may elect to update the preview. The preview display component may change and the table of contents on the title page may re-order and re-paginate to reflect changes.

The Section List Component may be where the user clicks on any of the individual existing sub-sections (individual module report(s)) to access its parameters and features for editing and modification.

Although each module's reports may be distinct and specific to the individual analysis, the user experience may be similar to help in user experience. Creating one type of report may be similar to creating other reports to aid in the process being intuitive.

The Report Section List Component 1304 may include a cross-section report unit, longitudinal profile report unit, pebble count report unit, hydro analysis report unit, survey data report unit, and/or images report unit.

The Cross Section Report Unit may allow the user to create and customize an individual cross-section report. When the user adds a Cross-Section Report a dialog box may open to guide the user through the initial report configuration. The first field may allow the user to specify a label or name for this Report Section. The user may select the Cross-Section file from which to generate a report, selecting from a menu listing of existing Cross-Sections within the Reach data file. They may select the report content from a menu that may include default choices of data only, data and chart, or chart only. They may specify from a menu the page layout or orientation of the report (either portrait or landscape). They may confirm the selections and add the Report Section. They may see their newly created report listed in the Report Section List Component. The created report may be added to the Master Report in the report preview.

The created Cross-Section Report may be shown in the Components list. Detailed information and controls regarding the Cross-Section Report may be available by expanding this entry in the List Component. If selected, the list item may expand to allow the user access to the customization options for the Cross-Section Reports. These may be divided into general categories such as: general options and chart options.

The general options for the cross-section report may include the title or name of this Cross-Section Report, the report content, the orientation, the number of pages, and whether to include an image (if available) within the report. The user may be allowed to increase or decrease the number of pages in a report. For example, they may have a very complex and long cross-section. The system may allow them to increase the number of pages such that the cross-section is split onto multiple pages for a much finer level of detail. The system may automatically reformat the report to fit on multiple pages while enabling overlap in the charts to allow for continuity and/or a visual connection between the pages.

The chart specific options may provide for customization of the charts found within the report. For the cross-section charts these may include options for the chart height, the number of horizontal and vertical lines, and whether to show features like the surface water elevation, bankfull indicator and the terrace(s).

The user may have multiple size options (e.g., menu selectable options) for the actual cross-section chart/plot including half-page, 3/4 page and full page.

The system's artificial intelligence and built-in safeguards like automatic re-formatting and automated overlap in multi-paged charts may help insure that the generated report fits within the report constraints even with the user's customization. They may save the format and return to the default view for the Report Section List Component.

The Longitudinal Profile Report Unit may allow the user to create and customize an individual Longitudinal Profile Report. Features set forth previously for the Cross-Section Report Unit may also apply to this unit. The user may select the Longitudinal Profile file to generate a report for from a menu listing of existing Longitudinal Profiles within the Reach data file. This unit may function in a similar manner and may include similar choices. Customized Longitudinal Profile Reports may be created in a similar manner as described above for other customized reports.

The system's artificial intelligence and built-in safeguards like automatic re-formatting and automated overlap in multi-paged charts may help insure that the generated report fits within the report constraints even with the user's customization. They may save the format and return to the default view for the Longitudinal Profile Report Unit.

The Pebble Count Report Unit may allow the user to create and customize an individual Pebble Count Report. This unit may be similar to the previous two units, but with some distinct differences. When the user adds a Pebble Count Report a dialog box may open to guide the user through the initial report configuration. The first field may allow the user to specify a label or name for this Pebble Count Report. There may be a list of existing Pebble Counts within the Reach data file that the user can select from. They may select the report content from a menu with default choices including chart, histogram, or chart and histogram. They may confirm the selections and add the report. The dialogue box may close. They may see the newly created report listed in the Report Section List Component. I may be added to the Master Report in the report preview.

The new Pebble Count Report may be shown in this Components list. Detailed information and controls regarding the Pebble Count Report may be available by expanding this entry in the List Component. If selected, the list item for the Pebble Count Report may expand to allow the user access to customization options for the Pebble Count Reports. The options for customization may include to modify the title, report content and whether to display an associated image within the report.

The system's artificial intelligence and built-in safeguards like automatic re-formatting and automated overlap in multi-paged charts may help insure that the generated report fits within the report constraints even with the user's customization. They may save the format and return to the default view for the Report Section List Component.

The Hydro Analysis Report Unit may allow the user to create and customize an individual Hydro Analysis Report. When the user adds a Hydro Analysis Report, a dialog box may open to guide the user through the initial report configuration. The first field may allow the user to specify a label or name for this report. The user may select the Hydro Analysis file from which to generate a report for from a menu listing of existing Hydro Analysis within the Reach data file. They may select the report content from a menu with default choices including Data and Analysis; Data, Analysis, and Graph; Graph Only and/or Stage Rating Table. They may confirm the selections and add the report. They may see the newly created report listed in the Report Section List Component. It may be added to the Master Report in the report preview.

The new Hydro Analysis Report may be shown in this Components list. Detailed information and controls regarding the Hydro Analysis Report may be available by expanding this entry in the List Component. If selected, the list item for the Hydro Analysis Report may expand to allow the user access to all the customization options for the Hydro Analysis Reports. The options for customization may include to modify the title, report content, whether to display an associated image within the report, and/or to modify the graph type.

The system's artificial intelligence and built-in safeguards like automatic re-formatting and automated overlap in multi-paged charts may help insure that the generated report fits within the report constraints even with the user's customization. They may save the format and return to the default view for the Report Section List Component.

The Survey Report Unit may allow the user to create and customize an individual Survey Data Report. This unit may present reports of the survey data. For example, if the user selects a Cross Section Data Report herein, they may be generating a detailed report of the Survey data associated with a Cross-Section, which may be different than the analyzed Cross-Section Reports found within the Cross-Section Unit (e.g., not survey specific). When the user adds a Survey Report a dialog box may open to guide the user through the initial report configuration. The first field may allow the user to specify a label or name for this survey data report. The user may select the Survey file for which to generate a report for from a menu listing of all existing Survey files within the Reach data file. They may select the report content from a menu with default choices of including Overview Summary, Cross-Section Survey Report, or Longitudinal Profile Report. They may confirm the selections and add the report. They may see their newly created report listed in the Report Section List Component. It may be added to the Master Report in the report preview.

The new Survey Data Report may be shown in this Components list. Detailed information and controls regarding the Survey Data Report may be available by expanding this entry in the List Component. If selected, the list item for this Survey Report may expand to allow the user access to the customization options for this report. The options for customization may include to modify the title, report content, the page orientation and/or whether to display an associated image within the report. For the report content and the page orientation, the user may be provided a menu of choices to select from.

The system's artificial intelligence and built-in safeguards like automatic re-formatting and automated overlap in multi-paged charts may help insure that the generated report fits within the report constraints even with the user's customization. They may save the format and return to the default view for the Report Section List Component.

The Images Report Unit may allow the user to create and customize an individual Images Report. When the user adds an Images Report a dialog box may open to guide the user through the initial report configuration. The first field may allow the user to specify a label or name for this Images Report. The dialog box may include displays which show the Images in the Reach file (e.g., those available for inclusion in the report) and those images that have been selected to be included in the report. A user may individually select the Images for inclusion. Some choices that may be used to automate the process and save time. These choices may include the Images found within the Reach file or to include Images the user has specified to be representative of features or modules (however, other optional choices can be specified in the user preferences). In a few clicks with defaults, the system may enable the user to generate an Images Report showing all Images or a report that shows only the critical representative images. They may also create a wholly customized Images Report by manually selecting the Images individually. They may confirm the selections and add the report. They may see their newly created report listed in the Report Section List Component. It may be added to the Master Report in the report preview.

The new Images Report may be shown in this Components list. Detailed information and controls regarding the report may be available by expanding this entry in the List Component. If selected, the list item for this Images Report may expand to allow the user access to all the customization options for this report. The options for customization may be to modify the title, the page orientation, the number of images per page (e.g., few images per page results in larger pictures and increases the reports length). They can edit the Images that are included in the report. For the page orientation and the images per page options, the user may be provided a menu of choices to select from.

The system's artificial intelligence and built-in safeguards like automatic re-formatting and automated overlap in multi-paged charts may help insure that the generated report fits within the report constraints even with the user's customization. They may save the format and return to the default view for the Report Section List Component.

The Rosgen Level II Classification Report Unit may allow the user to create and customize an individual Rosgen Level II Classification Report. When the user adds a Rosgen Level II Classification Report, a dialog box may open to guide the user through the initial report configuration. The first field may allow the user to specify a label or name for this report. The user may select the Rosgen Classification file they want to generate a report for from a menu listing of all appropriate files within the Reach data file. They may next select the report content from a menu with default choices including Level II data only, Level II classification data and flow chart. The next parameter they specify from a menu may be the page layout or orientation of the report (either portrait or landscape). They may confirm the selections and add the report. They may see their newly created report listed in the Report Section List Component. It may be added to the Master Report in the report preview.

The new Rosgen Classification report may be shown in this Components list. Detailed information and controls regarding the report may be available by expanding this entry in the List Component. If selected, the list item for this report may expand to allow the user access to the customization options for the Rosgen Classification Reports. These may be divided into general categories: general options and chart options.

The general options for the report may include the title or name of the Rosgen Classification report, the report content, the orientation, and whether to include an image (if available) within the report.

The detailed options may provide for additional customization within the report. For the Rosgen Classification reports these may include options including display of abbreviated cross-section and profile diagrams tailored for classification, a parameter summary comparison to accepted ranges, and whether to include an implications of classification summary.

The system's artificial intelligence and built-in safeguards like automatic re-formatting and automated overlap in multi-paged reports, automated diagram generation, automated flow chart generation, etc. may help insure that the generated report fits within the report constraints even with the user's customization. They can save the format and return to the default view for the Report Section List Component.

The Flow Measurement Report Unit may allow the user to create and customize an individual Flow Measurement Report. When the user adds a Flow Measurement Report a dialog box may open to guide the user through the initial report configuration. The first field may allow the user to specify a label or name for this report. The user may select the Flow Measurement file they want to generate a report for from a menu listing of available files within the Reach data file. They may select the report content from a menu with default choices including Weir Measurement & Specifications Report, Flume Measurement & Specifications Report, or Current Meter Calculation Report. They may specify from a menu a page layout or orientation of the report (either portrait or landscape). They may confirm the selections and add the report. They may see their newly created report listed in the Report Section List Component. It may be added to the Master Report in the report preview.

The new Flow Measurement Report may be shown in this Components list. Detailed information and controls regarding the report may be available by expanding this entry in the List Component. If selected, the list item for this report may expand to allow the user access to the customization options for the Flow Measurement Reports. These may be divided into general categories: general options and detailed options.

The general options for the Flow Measurement Report may include the title or name of this report, the report content, the orientation, and whether to include an image (if available) within the report.

The detailed options may provide for additional customization within the report. For the Flow Measurement Reports these may include options including display of a weir diagram (e.g., matched to the appropriate weir for this measurement), display of a flume diagram (e.g., matched to the appropriate flume for this measurement), or display of the cross-section diagram and measurement locations for the current meter flow measurement.

The system's artificial intelligence and built-in safeguards like automatic re-formatting and automated diagram generation, etc. may help insure that the generated report fits within the report constraints even with the user's customization regardless of the user's customization. They may save the format and return to the default view for the Report Section List Component.

The Report Preview Component 1306 may be a visual rendering of the Master Report. The preview may contain the Master Report including the title page and its constituent individual module reports. It may allow the user to see, edit, and alter the Master Report prior to finalizing for output, download, and/or printing. The user may use this preview as an opportunity to determine changes to its composition or format (e.g., alter the title page or change the individual module reports that are included or alter the format of the individual module reports) and determine if they want to change the sequencing order of the individual module reports within the Master Report. The user may scroll through the Master Report, and preview the pages (e.g., individual reports) within the report file.

The Report preview component 1306 may include: the Preview Display Unit and the Report Preview Component Controls Unit. The Preview Display Unit may be a window that shows a preview of the Master Report. A user may scroll to see individual module reports contained within the Master Report. Users may zoom in and out using the preview component controls to see portions at any desired scale or detail level.

The Report Preview Component Controls Unit may include controls to modify the preview display of the Master Report and to download the report. There may be buttons the user may click to zoom in and zoom out within the preview display. This may allow the user to see and review any portion of the Master Report at the scale of their choosing and enlarged to the most specific and detailed level.

The user may refresh the preview display to show the Master Report in a current form. The user may use this button after making changes to individual module report components.

When the Master Report has been reviewed, the user may select the download button and be provided with the Master Report in a printable format. To make sure that the file is printable, the Master Report file is may be provided in a portable document format (or other printable format).

The reports module may include Implementation Services 1402. The Implementation Services 1402 may include a Report User Interface Service 1404, a Reports Data Store Service 1406, a Report Data Service 1408, and/or a Report Controller Service 1410.

The Report User Interface Service 1404 may enable communication between the user interface components. This service may act as an intermediary between components. Messages pertaining to specific user actions within one component may be broadcast to other components that require that information. A component may respond to user actions that take place in another component.

The Reports Data Store Service 1406 may provide a local, in-memory representation of the currently open Report file. This representation may be updated based on user actions. Other modules within the application may be synchronized to the current state of the Report file.

The Report Data Service 1408 may provide an interface with the Server Application for purposes of storing and retrieving Report file data from the remote database. Report file data requests to the Server Application and responses from the Server Application may be routed through this service.

The Report Controller Service 1410 may provide common methods for other Components and Services within the Reports Module.

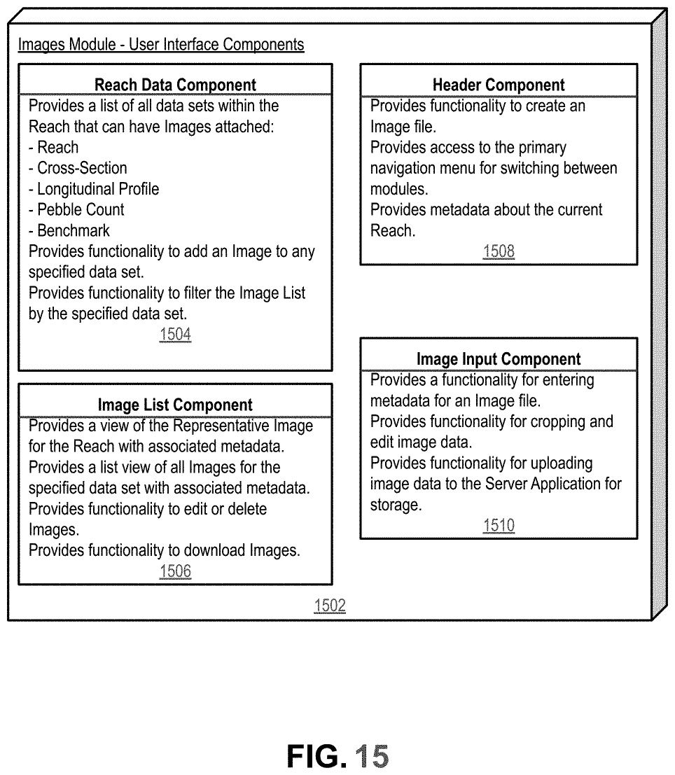

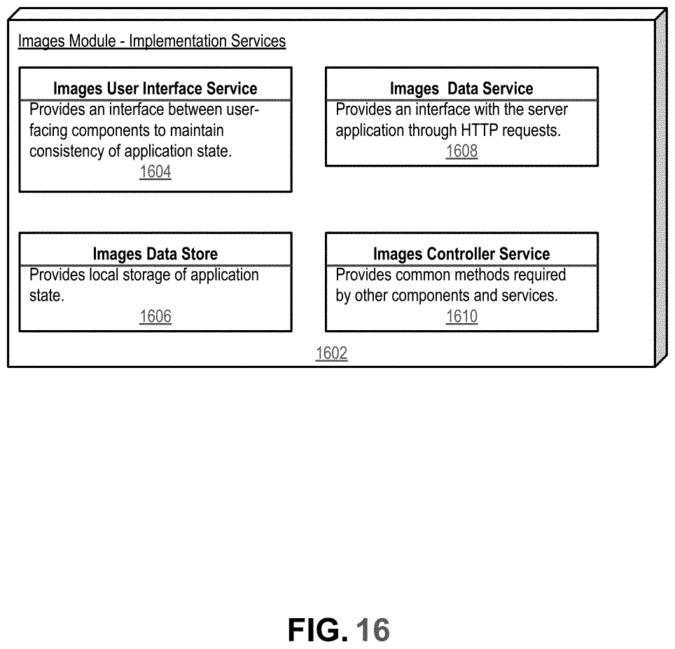

FIGS. 15-16 shows an architecture diagram illustrating a images module. The system may provide an image storage, association, and reference system. The Images Module may provide a user with the ability to upload, edit, associate, and store images within their Reach file. This integration may allow them to have their data and images in a location. Images that they take may be available to them in a user interface that also contains their data and analysis tools. The user may store and include in their Reach data set historic aerial photographs of an area so they can see changes over time. They may want to store a scan of a hydrograph from a nearby gage location. There are images other than photographs and the system will accept and process such other images.

The system may have a standardized image upload feature (e.g., Image Input Component 1510). This component may speed up the process of uploading and storing of photographs and images, receive information needed to properly categorize the photograph, and allow for the standardization of the images meta data, pertinent information, description and caption to be recorded at upload. The system's Image Input Component 1510 may allow a user to manipulate and edit the image. It can be shrunk or enlarged, cropped, and moved within the frame. By standardizing this process, a user may improve their efficiency while recording and capturing the pertinent information at the onset. When they return to a Reach file, the pertinent information may be there.

The system may allow for each Image to be stored with its pertinent information including its metadata, general information, specific photograph information. The user may add a brief summary description if they choose. Photographs may be stored with information needed to identify, explain, use and incorporate it. Using a standardized interface may provide the benefits of efficiency.

The system may allow images to be associated with other specific components of the data, such as with specific locations. The system may enable noting photos as being representative of both individual data sets and the overall reach. This may allow the user to quickly sort images. It may allow them to choose from multiple images and determine which is most representative. For example, they may have 7 images associated with a longitudinal profile. They may pick from those seven and assign one to be the most representative of the entire profile. They may do this for surveys, longitudinal profiles, cross-sections, pebble counts, hydro analysis, flow measurements, Rosgen classifications, etc. They may access their photographs. Viewing the reference images may allow a user to quickly develop an overall picture and sense of the reach or to aid their memory. The user may choose from the images and photographs from within the Reach file. The user may specify the one that is representative of the entire reach. This reach representative image may be used both within the application and included in reports.

Another benefit of the Images Module may be if a user performed a survey months or years ago and needs to return to the site and re-survey for monitoring or other purposes. Being able to quickly see images of the benchmarks (e.g., elevational control) that were previously installed may aid re-locating them when they go back for the re-survey. This may avoid wasting field time trying to locate an old benchmark to start the survey work. This module may enable them to do the same or similar associations with turning points, instrument heights, markers, etc. that are part of the surveying process.

Having images available may improve the analysis process by allowing the user to visually check features. For example, when performing a hydraulic analysis and trying to determine the most appropriate roughness coefficient to use (from within a range), the user may review a photograph to ascertain the vegetation or channel material and refine their hydraulic model.

Images may be automatically embedded into final reports, which may improve presentation. This may allow for an improved review of the analysis by someone unfamiliar with the site. As an example, if reports are generated and submitted as part of an environmental permit or review process, these reports may include specific photographs (e.g., selected by the user) in the report. These images may help the reviewer both understand the analysis and increase their confidence in the information being presented.

The images module may include User Interface Components 1502. The User Interface Components 1502 may include Header Component 1508, Image Input Component 1510, Reach Data Component (data tree) 1504, and Image List Component 1506.

The Header Component 1508 may render file information regarding the Reach and the specific Image file. The Header Component may provide functionality to create Image files by providing access to the Image Input Component. This component may provide access to the primary navigation menu for switching between modules.

The Image Input Component 1510 may be opened to add an Image to the Reach file. The Image Input Component 1510 may include: image file selection, general information for the image, and/or detailed information. This component may be dynamic and adapt as the user makes selections from the available choices.

The user may select the “Choose File” control. The user may choose the image file from their computer or device that they want to add. A preview of the image may appear and they can edit this image prior to upload. The system may provide basic image editing tools include rotating, cropping, zooming in or out, and moving the image (panning) within a frame. The user may input the general information which includes the basic image information like date, photographer, and organization.

The detailed information input may include a dynamic nature. The users may select a photo site type from a menu including choices such as survey, geomorphology, or other. The field options may adapt and respond based on the original site type selection.

They may specify the image's site type to be survey. They may choose from a survey menu to further specify the survey options (e.g., benchmark, longitudinal profile, cross-section, or pebble count). Further field(s) may be filled from a menu that further describes the image. For example, if they select benchmark, they may choose from a list of benchmarks within the file. Or, if they select longitudinal profile from the survey options, they may specify which longitudinal profile and the stationing.

They may specify the image's site type to be geomorphology. They may choose from a geomorphology menu to further specify the survey image (e.g., riffle, pool, run, tailout, bankfull indicator, etc.). Field(s) may be filled from a menu that further characterizes the image (e.g., typical or representative, distinct or unusual, or other).

They may specify the image's site type to be other. They may choose from a menu to further specify the survey image (e.g., example vegetation, bank erosion, overflow channel, diversion, grade control, etc.).

Regardless of site type chosen, the process in inputting information may involve orienting the photograph and view relative to the channel. They may specify the location or position of the photograph from a menu (e.g., in-channel, left bank, right bank or other). They may specify the direction or view of the photograph from a menu (e.g., upstream, downstream, across channel, or other). If the user specified the geomorphology photo site type, they may click on a box to make the photograph representative of the specific geomorphic feature reach. A field may be a clickable box allowing the user to specify the image as representative of the overall reach. A field may be available for the user to make comments or provide a specific caption for reference.

The fields may be editable. The user may select the “Done” button and the image may be uploaded to the Reach file. The Image Input Component dialogue input box may close and the system may complete the image upload and storage/association process. The image may be available in the Images Module and loaded into the Images tabs in other modules. For example, if the uploaded image is from a cross-section, then the image may automatically be present under the Images tab for that cross-section in both the Survey Module and in the Cross-Section Analysis and Graphing Module. It may be available in the hydro analysis module for that cross-section. It may be available for any reports on that cross-section.

The Reach Data Component (data tree) 1504 may be a hierarchical organizing structure for all the images within a Reach file. It may provide an expandable and collapsible tabular summary of the Images and their associations. It may be formatted to be similar to the data tree found on the Reach Dashboard Module tab to help intuitive understanding and access to images quickly and easily. Images may be listed under the module that they are associated with. For example, the Survey heading may contain Images associated with the Survey data. Pebble Count Images may be found under the Pebble Count header, etc.

When the user selects a specific header, the data tree may expand and the images shown in the Images List Component may change to show those images within that header subject. For example, if the user clicks on the Flow Measurement heading, images associated with flow measurements may be shown in the Images List Component.

The Images List Component 1506 may be a visual display of all the Images and their associated data. Images within the Reach file may be displayed at the level of and specification of the user's choices within the Reach Data Component. If the user specifies or selects the Reach, then photographs and images within the Reach file may be displayed in this component. As they further specify, the displayed images may change and become more refined. The Images List Component may include: Representative Image Unit and the Other Images Unit. Within this component, images can be edited, deleted, or the original image can be restored.

The Representative Image Unit may show a representative image for the specific data type selected. If the user is at the Reach level in the data tree component, then the Image that has been selected by the user to be representative of the overall reach may be displayed (e.g., if this has been specified). If the image has not been specified, this unit may have no image present. This lack of picture may indicate that the user has yet to specify an image as being representative of the overall reach.

As the user restricts the data and moves further into their data by specifying classifications or filters, the Image displayed may also change. For example, if they select a specific Longitudinal Profile, then the Image that has been selected by the user to be representative of that Longitudinal Profile may be displayed (e.g., if it has been specified). If it has not been specified, this unit will may have no image present. This lack of image may indicate that they have yet to specify an image as being representative of that feature.

The Other Images Unit may show images for the specific data type selected, along with metadata pertaining to each Image. This unit may display the image, its associated information, and control functions (e.g., edit, delete, etc.) If the user is at the Reach level in the data tree component, then this unit may display the images within the Reach file. The user may scroll to see each image and its associated data. As the user restricts their interest and moves further into their data by specifying interests, the Images displayed may also change. For example, if they select a specific Cross-Section, then the images that are associated with that Cross-Section may be displayed.

The Images module may include Implementation Services 1602. The Implementation Services 1602 may include an Images User Interface Service 1604, Images Data Store Service 1606, Images Data Service 1608, and/or Images Controller Service 1610.

The Images User Interface Service 1604 may allow for communication between the user interface components. This service may act as an intermediary between components, so that messages pertaining to specific user actions within one component may be broadcast to other components that require that information. Thus, a component may respond to user actions that take place in another component.

The Images Data Store Service 1606 may provide a local, in-memory representation of the currently open Image file. This representation may be updated based on user actions, so that other modules within the application may be synchronized to the current state of the Image file.

The Images Data Service 1608 may provide an interface with the Server Application for purposes of storing and retrieving Image file data from the remote database. Image file data requests to the Server Application and responses from the Server Application may be routed through this service.

The Images Controller Service 1610 may provide common methods for other Components and Services within the Images Module.

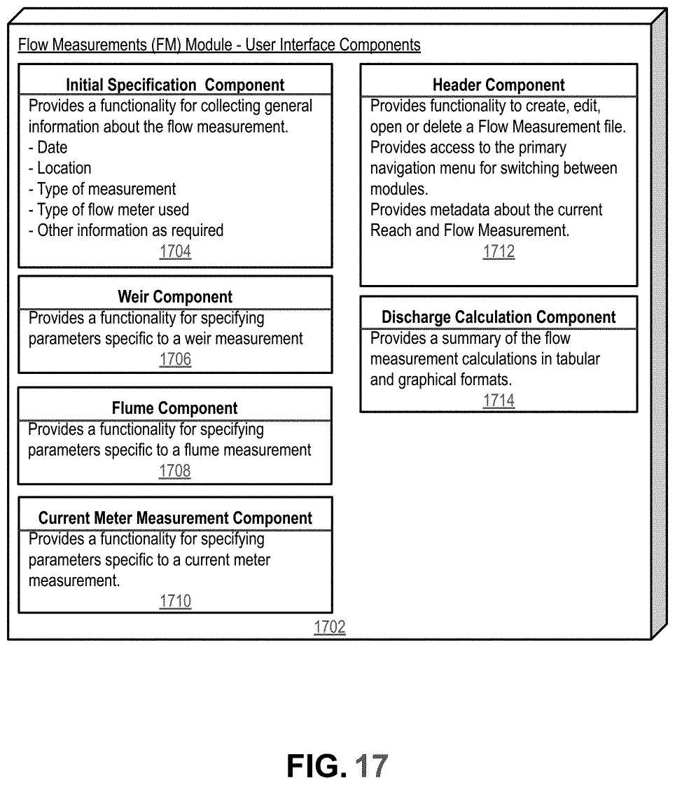

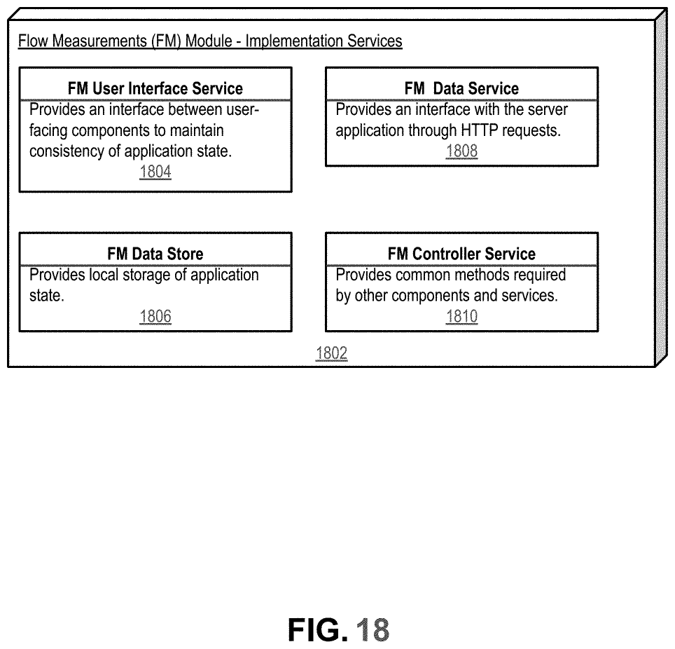

FIGS. 17-18 shows an architecture diagram illustrating a flow measurements module. Flow measurements may be used within a varied range of study including geomorphologists, hydrologists, engineers, biologists, geographers, geologists, and ecologists. The measurements may characterize the flow or discharge being conveyed within a channel at a given date and time and at a specific stage height or water surface elevation. Flow measurements may be used to calibrate hydraulic models by providing specific data points (e.g., flow or discharge) at a stage height or elevation that may be compared to a model's predicted discharge for that same stage height or elevation. When developing a hydraulic model, the modeler may alter the model type and parameters to produce a predicted discharge that matches the measured or known discharge. This may be done iteratively until the model is successfully calibrated over a range of measured values (e.g., differing stage heights and elevations). As such, flow measurements may be important as both individual distinct data points and as part of a larger overall prediction of discharges for a channel.

This module may be designed to aid in the processing of specific flow measurements and, through cross-integration, in the development of calibrated hydraulic models developed in the Hydro Analysis Module. This cross-integration may be an example of the benefits of the system's integration of data between individual component within a Reach file. Data, analysis, and results from other modules may be automatically available and used herein, which may result in speeding up the flow measurement analysis, calculations and increasing the precision of the results. There may be built-in reports that will synthesize the results of the Flow Measurement module.

This module may include distinct components including: the Weir component, the Flume component, the Current Meter Measurement component, and the Discharge Calculation Summary Component.

Results of the Flow Measurements analysis may be available in tabular format or in graphical charts and plots. These results may be further customized by the user. Additional parameter fields may be added to the tables and adding additional chart types may be added and/or the charts can be inverted. The user may control how they develop and how they display their Flow Measurements analysis and modeling results. There may be already pre-built templates in the Reports Module so the user can easily output professional reports for all their Flow Measurements analysis.

The Flow Measurements Module may include User Interface Components 1702. User Interface Components 1702 may include a Header Component 1712, Initial Specification Component 1704, Weir Component 1706, Flume Component 1708, Current Meter Measurement Component 1710, and Discharge Calculation Summary Component 1714.

The Header Component 1712 may display critical file information regarding the Reach and the specific Flow Measurement file. The Header Component 1712 may include file controls for the Flow Measurement files located in a menu. Working within the overall individual Reach file, these controls may allow the user to add a new Flow Measurement to the file, edit an existing Flow Measurement file, or delete a Flow Measurement file. Clicking on the “New Flow Measurement” menu choice may begin the process of creating a new Flow Measurement file within the Reach file and the Initial Specification Component may open.

The title bar may provide access to a navigation menu that allows for the user to move from one analysis module to another. Within the title bar, users may be given basic information. They may navigate between individual Flow Measurement files. They may be able to move between the different individual analysis components and modules within the specific individual Reach file.

The Initial Specification Component 1704 may allow the user to quickly initiate the processing of a flow measurement. The system may guide them through this process to collect and store general information about the flow measurement including the date of the flow measurement, date of the analysis, location of the flow measurement (e.g., latitude and longitudinal coordinates), the location of the flow measurement relative to the reach and survey information, the type of flow measurement, and the type of current meter that was used.

The date of measurement and analysis may be fields completed using either user input or date selection from a pop-out calendar. The latitude and longitude coordinates may be specified using either direct user input or menus. The system may allow for the association of the flow measurement with or to the reach location and survey information. The user may associate the flow measurement to different locations within the reach data including: to the longitudinal profile stationing, to a specific cross-section, and or to a specific pebble count location. The user may select from any or all of these and may be prompted with drop down menus for each of these that include the appropriate potential choices. For example, if they choose to associate the flow measurement with the longitudinal profile, they may select the station location of the measurement from a list of the existing longitudinal profile stations. If they elect to associate the flow measurement with a cross-section, they may select from a list of the existing Cross-Section files. If they elect to associate the flow measurement with a specific pebble count, they may select from a list of the existing Pebble Count files. Sometimes, data collection sequencing or field conditions may result in the flow measurement being collected outside the reach or outside the survey areas of the reach. The system may allow for this by providing an “Outside of Survey Area” option. This option may include a field for the user to describe the location of the flow measurement relative to the reach.

The system may allow the user to specify the type of flow measurement to be processed from a list of potential choices: weir measurement, flume measurement, current meter measurement, and/or current meter using an existing cross-section.

The user may select the type of current meter that was used for the flow measurement. This may be specified if the flow measurement is derived from a current meter measurement (e.g., it does not apply to weir and flume based measurements). The user may select from a menu of types of current meter types. The system's default choices may include commonly used current meters such as: Price type AA current meter and the pygmy-type. Other current meters may be added to their choices in their preferences section.

The user may be asked to review, verify, and save their initial specifications and description for the flow measurement before proceeding. When they record their settings by clicking on the “Save” button, the Initial Specification Component may close. The flow measurement component may open. They may proceed with performing the data entry and flow measurement analysis to determine the discharge.

The Flow Measurements Module may include a Weir Component 1706. Weirs may be defined as a structure built across an open channel to measure the rate of flow of water (which may typically be installed in smaller channels). The discharge across a weir may be determined by a formula if the elevational difference between the water surface elevation above and below the weir is either known or measured. Depending on the weir's installation, it may have a staff gage installed that allows the elevation difference to be directly read while in the field. When this direct reading is not available, the elevation of the water surface upstream and downstream of the weir may be collected by surveying.

Some situations may require that the calculated flow be modified by a specific correction process. Common weirs that have been historically installed and used for measuring water conveyance in open channels may include: the standard contracted rectangular weir, the standard suppressed rectangular weir, standard Cipolletti weir (e.g., trapezoidal weir), and the standard 90° v-notch weir.

This component of the system may process field measurements taken at the weir locations to determine the flow of water at the time of the field measurement for each of the four standard weir types. Selecting from a menu, a user may specify what type of weir is being used for the flow calculation. They may enter the direct gage height reading or the survey information for the upstream and downstream locations (including the instrument height and invert or foresight readings). Using a formula for the specified weir, the system may calculate the vertical difference across the weir and determine the discharge flowing in the channel.

This component may ask specific questions to determine whether a correction factor needs to be applied. If no correction is needed, the user may be asked to verify and then save the flow calculations. If a correction is needed, for example if the weir is submerged, then the system may query the user for additional specifications and then calculate the correction and the new corrected discharge. The user may then be asked to verify and save the revised flow calculations.

The Flow Measurements Module may include a Flume Component 1708. A Parshall flume may be a specially shaped open channel flow section that may be installed to measure the rate of flow of water. The design and shape of the flume may produce a differential head (e.g., change in the water surface elevation) across the throat of the flume. This head differential may be measured and related to discharge. Flow within a flume may be in conditions such as: free flow or submerged flow conditions. Under free flow conditions, the flow through a parshall flume of known size may be calculated based off the differential head. Under submerged flow conditions, the flow predicted by the free flow condition may be corrected with additional calculations. Similar to a weir, depending on the flume's installation, it may have a staff gage installed that allows the elevation difference across the throat of the flume to be directly read while in the field. When this direct reading is not available, the elevation of the water surface upstream and downstream of the flume may be collected by surveying.

Parshall flumes may have complex three dimensional shapes with specifications for the surfaces that are based on the throat width. If the width of the throat and the head differential of the water surface elevation are both known, then the flow through the flume may be determined for a specific stage height.

This component of the system may process field measurements taken at the flume locations to determine the flow of water at the time of the field measurement. Selecting from a drop-down menu of typical flume widths (with the ability of the user can specify additional choices in their user preferences if a specific flume with is not found in the standard flume widths), a user may specify what width of flume is being used for the flow calculation. They may enter either the direct gage height reading or the survey information for the upstream and downstream locations (including the instrument height and invert or foresight readings). Using the appropriate formula for the specified flume width, the system may calculate the vertical difference across the flume and determine the discharge flowing in the channel.

Specific questions may be presented to determine if free flow or submerged flow conditions exist to make sure no correction factor needs to be applied. If no correction is needed, the user may be asked to verify and then save the flow calculations. If a correction is needed, for example submerged flow conditions exist, then the system may query the user for additional specifications and then calculate the correction and the new corrected discharge. The user may be asked to verify and save the revised flow calculations.

The Flow Measurements Module may include a Current Meter Measurement Component 1710. A common method for determining flow in an open channel may be to measure it with a current meter and then analyze it for discharge. The basic premise may be that discharge or flow is equal to the cross-sectional area of the water multiplied by the velocity. Current meters and measuring rods may have been developed and empirically calibrated to measure the average water velocity in a particular vertical column of water. Common meters may include the Price type AA current meter and the pygmy-type current meter. Watershed professionals may use these and other current meters in conjunction with specific measuring rods to estimate the velocity of water flowing in a particular column of water. A specific measuring rod may be used in flow measurements because it is scaled such that it measures the depth and then allows the attached meter to be set at the correct height to measure the average velocity of the water. Common current meters may include cups that rotate around an axis. The user may count and record a number of rotations that occur over a period of time. There may be data loggers which automatically record the depth, number of rotations, and time for each measurement. Calibrated equations may be developed for each meter that convert the number of rotations and the time to an average velocity value.

In the field, the flow area across a channel may be typically measured and then subdivided into individual vertical components. For example, a practitioner may measure the flow in a 30′ wide channel and elect to take 10 individual measurements (e.g., break the total flow area into 10 components each with a width of 3 feet). They may proceed across the channel to the first measurement location, record the depth, set the flow meter at the appropriate height, and measure/record the number of rotations in a given time period (both of which may be recorded). They may complete the flow measurement by repeating this process until they have transected across the entire channel and recorded their measurements for column or subdivision. This field data may be processed by determining the cross-sectional area for each column (e.g., using the width and average depth) and calculating the average velocity (e.g., based on the rotations and time from the current meter). The discharge for each column or subdivision may be determined by multiplying the area by the velocity. The total flow may be calculated by summing the discharge of all the measured columns or subdivisions. Note that the area may be calculated based of the average depth of the column and the accuracy of this calculation is dependent upon the width of the column and the degree of variability in the surface of the channel bottom. If the channel bottom is extremely variable, the average depth measured in the horizontal middle of the channel may not be a true average and may increase the error in the area and flow calculations. Conversely, even with a gradually changing channel surface, this methodology may produce the same errors if the width of the subdivision is excessive. The system may allow for the use of the standard technique or a more accurate technique using an existing surveyed cross-section. The standard techniques and process may associate a discharge with depth and not the actual water surface elevation or the reference elevation. There may not be a direct link or correlation possible between a flow measurement and the more rigorous information from the surveyed longitudinal profile(s) or cross-section(s). The system may enable the user to eliminate this shortcoming and provide for the direct connection of survey data to flow measurements which may increase the accuracy, efficiency, and the correlation between information types.

This component of the system may process current meter-based field measurements to determine the flow of water at the time of the measurement. There may be units within this component: the cross-section unit and the standard flow measurement unit.

In the cross-section unit, the system may allow for processing the flow measurement if it was collected at the location of a surveyed cross-section and the more detailed and accurate surveyed cross-sectional information is used to describe the channel boundary and this information is used for area calculations. The benefit of this may be faster data collection, utilization of the more detailed and accurate channel boundary. This may provide more accurate area calculations and resulting discharge calculations, a direct connection to other survey information including the reference elevation, and/or the ability to directly correlate flow measurements to stage heights and elevations within the Hydro Analysis module (which may aid in calibration of any hydraulic model).

In the standard flow measurement unit, the system may process the flow measurement that was collected using the standard techniques and no direct elevational connection may be made between surveyed cross-sections, longitudinal profile(s), or a reach's reference elevation datum.

The may include components such as: data input table and a graphical display. Because the user has already selected a surveyed cross-section associated with this measurement, the graphical display (e.g., a system configured to render a graphical display) may already show the existing cross-section. The user may be asked to select the number of actual readings that were taken and the overall width of the water at the time of the measurement.

The system may generate a flow measurement input table that will be completed prior to performing the actual flow or discharge calculations. The system may automatically populate the table with the determined number of rows (e.g., one row for each actual current meter measurement). The system may automatically populate each row with the start and end boundaries for that section, the midpoint of the measurement section (e.g., the location where the reading should have taken place), and the calculated depth at the point of the reading. These fields are editable if the actual field data varies from the ideal. There may be blank fields for depth, calculated meter depth (system generates based on the depth), revolutions, and time which the user will have to complete for each section or reading. If the data the user enters deviates from what the system expects, the user may be given a warning and allowed to correct or revise their data or override the system generated values. Once finalized, values that used in calculations may be selected based on accuracy.

As the user inputs the information, the system may supplement the graphical information by displaying the actual section boundaries and reading locations. This display may enable the user to visually determine and verify that what they are entering actually matches their memory of the flow measurement transect across the channel. The system may generate warnings that some of their inputs do not match what the system has determined they should be. When the user has completed the data entry for all the individual segments and readings, they may be asked to verify the information and then save the data by clicking on a “Save” button. When they click the save button, the data may be saved to the appropriate file and this unit closes and the system displays the final component (e.g., Discharge Calculation Summary Component).

The Standard Flow Measurement Unit may include components such as: data input table and a graphical display. The user may be asked to select the number of actual readings that were taken and the overall width of the water at the time of the measurement.

The system may generate a flow measurement input table that may be completed prior to performing the actual flow or discharge calculations. The system may automatically populate the table with a determined number of rows (e.g., one row for each actual current meter measurement). The system may automatically populate each row with the start and end boundaries for that section and the midpoint of the measurement section (e.g., the location where the reading should have taken place). These fields may be editable, such as when the actual field data varies from the ideal. There may be blank fields for depth, calculated meter depth, revolutions, and time for which the user may have to complete for each section or reading.

As the user inputs their information, the system may build a graphical display of the section measured (similar to a cross-section) but based on the width and depth measurements. This display may help the user visually determine and verify that what they are entering actually matches their memory of the flow measurement transect across the channel. When the user has completed the data entry for all the individual segments and readings, they may be asked to verify the information and then save the data by clicking on a “Save” button. When they click the save button, the data may be saved to the appropriate file. This unit may close. The system may display a follow-on component (e.g., Discharge Calculation Summary Component).

The Discharge Calculation Summary Component 1714 may be the final component (in terms of access order) within the module and may be where the discharge calculation is summarized for the specific flow measurement within the study segment. This component may show the date of the flow measurement, date and time, if specified, of the flow measurement calculation, the location of the flow measurement, the water surface elevation and stage height at the time of the measurement, the source of the measurement (e.g., weir, flume, or current meter), and the calculated discharge.

If it was a current meter flow measurement or was developed using the standard flow measurement unit, the system may render a graph of the interpreted cross-section showing distance and stage heights, the water surface, the current meter locations, and the sub-section partitions. It may have a tabular summary of related information including the cross-sectional area, mean velocity, wetted perimeter, hydraulic radius. It may interpret the overall manning's n value given the calculated discharge.

If it was a current meter flow measurement developed using the cross-section unit, the system may render a graph of the surveyed cross-section showing distance and stage heights and elevations, the water surface, the current meter locations, and the sub-section partitions. It may include a tabular summary of related information including the cross-sectional area, mean velocity, wetted perimeter, hydraulic radius. It may interpret the overall manning's n value given the calculated discharge.

The Flow Measurements Module may include Implementation Services 1702. The Implementation Services 1702 may include FM User Interface Service 1804, FM Data Store Service 1806, FM Data Service 1808, and FM Controller Service 1810.

The FM User Interface Service 1804 may allow for communication between the user interface components. This service may act as an intermediary between components. Messages pertaining to specific user actions within one component may be broadcast to other components that require that information. Thus, a component may respond to user actions that take place in another component.

The FM Data Store Service 1806 may provide a local, in-memory representation of the currently open Flow Measurement file. This representation may be updated based on user actions, so that other modules within the application may be synchronized to the current state of the Flow Measurement file.

The FM Data Service 1808 may provide an interface with the Server Application for purposes of storing and retrieving Flow Measurement file data from the remote database. Flow Measurement file data requests to the Server Application and responses from the Server Application may be routed through this service.

The FM Controller Service 1810 may provide common methods for other Components and Services within the Flow Measurement Module.

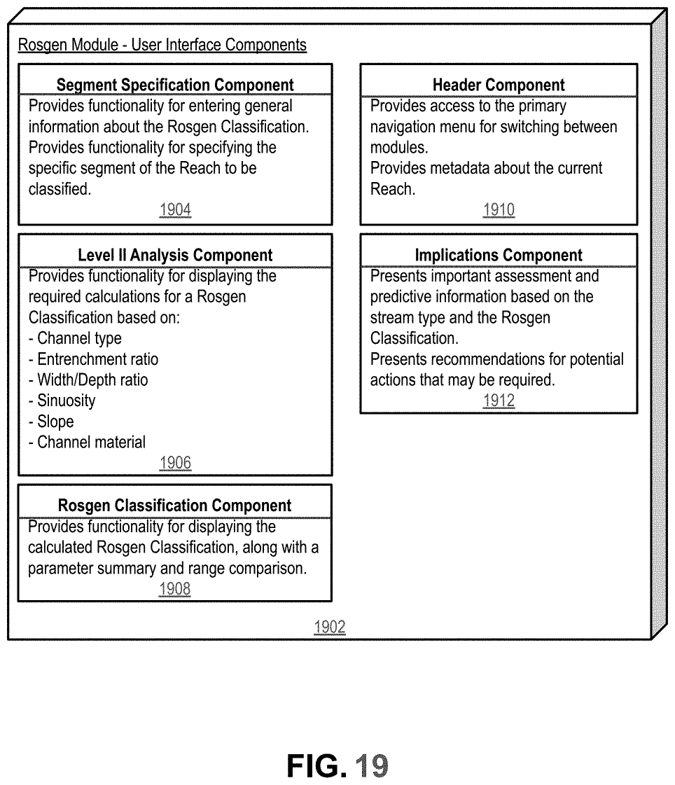

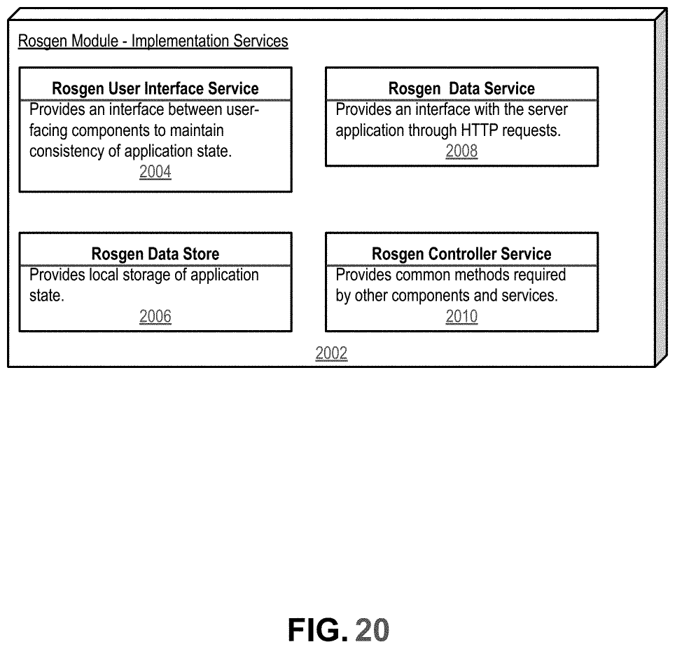

FIGS. 19-20 shows an architecture diagram illustrating a Rosgen analysis module. The Rosgen Classification system may be a tool for watershed analysis and may be used within a varied range of study including geomorphologists, hydrologists, engineers, biologists, geographers, geologists, and ecologists. It may provide a quantitative means of summarizing physical parameters of a stream or river, regardless of size, and classifying the water body or specific reach with an understandable code. Because it quantitatively analyzes physical parameters that can be measured, it may be less subjective than other classification schemes, as it may be both reproducible and verifiable. It may be useful across varied watershed fields because it may be used and implemented as enables understanding the physical parameters and/or function of a stream or reach referring to the Rosgen classification. A unique value to the classification system may be that although it is based on physical parameters it may aid in assessing the biological, vegetative, and ecological aspects of a river or stream.

Rivers and streams may be inherently dynamic systems that are ever-changing and going through a fluvial geomorphic change process. The Rosgen system may be a valuable tool because of its predictive nature that may allow for a practitioner to understand how the river or stream has changed (e.g., history), may be changing (e.g., current dynamic situation), how it may be changing in the future (e.g., predictive), and what is impacting or controlling the system either positively or negatively. A classification in a reach (e.g., segment of a river or stream) may provide insight and information upstream and downstream of the studied reach and may provide insight into the entire watershed health, function, and impacts.

There may be two levels to the Rosgen classification system. Level I may be a generalized classification based on visual data and elementary field data. A Level II classification may be more detailed and may involve quantifying the physical parameters through detailed field measurement and characterization, producing a more refined classification/categorization.

One drawback to the Rosgen classification system for current analysis techniques may be the performance of various measurements and analysis. Then the technique would manually proceed through the classification system in a stepwise approach that is not automated.

The Rosgen Module may automate this process and reduce the time it takes to perform a Level II classification. This automation may reduce and/or eliminate the duplication of data, and increase the accuracy of results. This module may be another example of the benefits of cross-integration because data, analysis, and results from most of the other modules are all automatically available and used herein, which may speed up the classification and increasing the precision of the results.

As with other modules, there may be built-in reports that synthesize the results of the Rosgen classification module. Results of the Rosgen analysis may be available in tabular format or in graphical charts and plots. These results may be further customized by the user. Additional parameter fields may be added to the tables and adding additional chart types may be added and/or the charts can be inverted. The user may control how they develop and how they display their Rosgen analysis and modeling results. There may be already pre-built templates in the Reports Module so the user can easily output professional reports for all their Rosgen analysis.

This module may include of distinct components such as: the Header Component 1910, the Segment Specification Component 1904, the Level II Analysis Component 1906, the Rosgen Classification Component 1908, the Implications Component 1912. The Level I classification may be provided by the user in the initial Reach file creation. The Level II Analysis component may provide a bulk of the processing and analysis. Necessary data may be imported from other modules. Some data may be entered by the user to allow for the detailed Level II Rosgen classification to be completed. The Rosgen Classification component may present the results of the analysis by providing the actual Level II Rosgen classification for the segment and by providing any specific characteristics that are approaching range boundaries or other important information. The Implications Component 1912 may be the last component (e.g., in terms of access order) and may provide important assessment and predictive information that may be inferred from the classification.

The Rosgen Module may include User Interface Components 1902. The User Interface Components 1902 may include a Header Component 1910, Segment Specification Component 1904, Level II Analysis Component 1906, Rosgen Classification Component 1908 and Implications Component 1912.

The Header Component 1910 may display file information regarding the Reach. Reach information displayed may include the reach name, region, and level I Rosgen classification. The Header Component may include file controls for the Rosgen classification files located in a menu. Working within the overall individual Reach file, these controls may allow user to add a new Rosgen Classification to the file, edit an existing Classification file, or delete a Classification file. Clicking on the “New Level II Classification” menu choice may begin the process of creating a new Classification file within the Reach file and the Segment Specification Component will open. The title bar may provide access to a navigation menu that allows for the user to move from one analysis module to another.

The Rosgen Module may include a Segment Specification Component 1904. To create a new Rosgen Classification file, the user may select the “New Level II Classification” button found within the Header Component file menu choices. The system may open a user-friendly initial input dialogue box that allows the user to specify the name, date, and what area of the reach is being classified. They may verify the valley type and other information that was first associated with the reach as part of the Level I classification.

A field of this component may be the name for the individual Level II Classification file. This may be pre-filled, but the name may be edited and customized by the user. The date filled may be pre-filled to the current date and may be the date the Level II Classification and analysis is being performed.

The user may to specify what part of the reach is being classified. They may select from a menu with three choices: entire reach, portion of reach, or other. If they select the “Entire Reach” then this input may be finalized and the user may move to the next component. If they select a “Portion of the Reach” option then they may be prompted to delineate the boundaries of this classification segment. The default setting may be to use the longitudinal profile stationing. The user may select both the segment beginning and ending from drop down menu listing the possible LP stations. If they user may selects the “Other” option, then they may be provided an editable field to enter a short description. Once the fields have been completed the user may save the general specifications and the system may navigate to the next component of this module which may automatically populate fields, based on the segment specifications, with the necessary data from all other modules.

The Level II Analysis Component 1906 may include the information, calculations to perform a detailed Level II classification and to assign a stream type to the designated stream or river segment. This component may draw information, as appropriate, from several of the other modules. This may provide benefits including ensuring that the classification is done using actual data, eliminating the errors associated with re-entry, and speeding up the process. This may be another example of the value of the system's overall cross-integration between modules improving analytical results and improving efficiency. For example, the Cross-Section Analysis & Graphing module may provide the width/depth ratio that is automatically imported from the appropriate Cross-Section.

To perform a Level II classification or determine the stream type for the specified reach or segment of a reach, there may be 6 parameters that are determined or calculated. These may include the channel type (e.g., single or multiple thread), entrenchment ratio calculation, width/depth ratio, sinuosity calculation, slope specification, and channel material specification. This component may complete these inputs, tasks, and calculations to allow for a stream type classification to be assigned. This process may be automated by importing the appropriate information from other modules.

The system may use the user-specified segment boundaries to determine portions of the reach file to be available for data import into this module and component. If the user specified that the classification is for the entire reach, then data for the appropriate parameters within the Reach file may be available for the Level II analysis. However, if the user indicated a segment of the total reach, then elements within that segment may be available to provide information to the Level II analysis. For example, if a reach file contains three cross-sections and one is within the designated segment boundaries, then the one cross-section may be used to provide information for this Level II analysis and data from the remaining two cross-sections may not be imported or available.

The Channel Type Unit may determine whether the segment to be classified is a single-thread channel or multiple thread channel. There may be a box for each of the options. This unit may be semi-automated because the system may analyze the available cross-section(s) and make the determination based on the information it has by placing an “x” in the appropriate choice (e.g., single channel or multiple thread). The user may be asked to verify or confirm this selection before they can navigate to the next unit.

Benefits of the system's cross-integration and data sharing between modules may be possible because the system utilizes data and information from the Cross-Section Analysis & Graphing Module for this unit. The system may analyze each available existing cross-section(s) within the segment to determine if there are secondary channels or overflow channels that convey significant capacities of water below the bankfull stage elevation. If so, then this segment may be considered a multiple thread channel system and the appropriate box may be pre-selected by the system. If not, this segment may be considered a single-thread channel system and the appropriate box may be automatically pre-selected by the system. The user may be prompted to verify the choice before navigating to the next analytical unit (e.g., Entrenchment Calculation Unit).

The Entrenchment Calculation Unit may determine the degree of entrenchment, the amount of available floodplain or area the area available for the conveyance of flood flows. In the Rosgen Classification system, stream and river channels may be entrenched, moderately entrenched, slightly entrenched. The degree of entrenchment may be a quantitative analysis based on the entrenchment ratio for the segment to be classified.

These benefits of the system's cross-integration and data sharing between modules may be possible because the system may utilize data and information from the Cross-Section Analysis & Graphing Module for this unit. Specifically, the system may analyze each available existing cross-section within the segment to determine the entrenchment ratio. Each cross section may include a field that displays the calculated entrenchment ratio and a field for the average entrenchment ratio. The system may use this information to determine the degree of entrenchment. These may be editable fields that the user can alter or change. The system may include built in safeguards to protect the quality of this unit's analysis. For example, the user may be prompted if there is a cross-section lacking sufficient information to calculate an entrenchment ratio. They may be warned if there is a difference in entrenchment between cross-sections (typically occurs when a stream changes stream types within a segment and indicates that the boundaries should be revised). The system may, based on the calculations, determine the degree of entrenchment (e.g., whether it is entrenched, moderately entrenched, or slightly entrenched) within the study segment.

The user may verify both the analytical results and the degree of entrenchment determination. Once verified, the user may proceed to the next analysis unit (Width/Depth Ratio Unit).

The Width/Depth Ratio Unit may determine the width/depth ratio found within the study segment, which may be a determinative parameter within the Rosgen Classification system.

The benefits of the system's cross-integration and data sharing between modules may be enabled because the system utilizes data and information from the Cross-Section Analysis & Graphing Module for this unit. The system may analyze each available existing cross-section(s) within the segment to determine their width/depth ratio. Each cross section may include a field that displays the calculated width/depth ratio. There may be a field for the average width/depth ratio. These may be editable fields that the user can alter or change. The system may include built-in safeguards to protect the quality of this unit's analysis. For example, the user may be prompted if there is a cross-section lacking sufficient information to calculate a width/depth ratio. As another example, they may be warned if there are substantive differences in the width/depth ratio between cross-sections (e.g., typically occurs when a stream changes stream types within a segment and indicates that the boundaries should be revised).

The user may verify the analytical results and the segment's specified width/depth ratio. Once verified, the user may navigate to the next analysis unit (e.g., Sinuosity Unit).

The Sinuosity Calculation Unit may determine the sinuosity (e.g., the degree of meandering) of the channel within the study segment. The sinuosity may be expressed as a quantitative number and, in the Rosgen classification system, as a qualitative class (low sinuosity, moderate sinuosity, high sinuosity, or very high sinuosity) which may be based on the quantitative value.

There may be a box for each option. This unit may be semi-automated because the system may assist the user in establishing the sinuosity, including allowing them to use several different means of determining the sinuosity (e.g., measured channel length/divided by straight line length or by the relationship between average channel slope and valley slope). Each sinuosity value may be presented for review and confirmation as is the qualitative overall classification of the sinuosity. The user may be asked to verify or confirm this selection before they can navigate to the next unit.

The benefits of the system's cross-integration and data sharing between modules may be enabled because the system utilizes some data and information from the Longitudinal Profile Analysis & Graphing Module for this unit. The system may provide appropriate slope information from within the study segment. The user may be prompted to verify the choice before navigating to the next analytical unit (Entrenchment Calculation Unit). The user may verify the analytical results and/or the segment's specified sinuosity classification. Once verified, the user may proceed to the next analysis unit (Slope Specification Unit).

The Slope Specification Unit may determine the channel slope and assign a slope range within the study segment. In the Rosgen Classification system, the slope value and/or the range that the slope value falls within may be a parameter for the stream type and allow for stream type sub-specification. These may be quantitative values calculated by the system.

The benefits of the system's cross-integration and data sharing between modules may be enabled because the system utilizes data and information from the Longitudinal Profile Analysis & Graphing Module for this unit. The system may analyze each slope values from within the segment. Overall slope values may be calculated within the boundaries of the segment for both the water surface elevation and the bankfull stage height. The system may use this information to determine the slope values. These may be editable fields that the user can alter or change. The system may include built-in safeguards to protect the quality of this unit's analysis. For example, the user may be prompted if there is a significant deviation between average slope values for the water surface elevation slope and/or the bankfull indicator slopes. It may prompt the user if there is a significant change in slope within the segment for these parameters. It may warn if there are localized differences in slope that are statistically significant in relation to the overall slope and/or indicate a localized alternative stream type. The user may verify the analytical results and/or confirm the overall segment slope value. Once verified, the user may proceed to the last analysis unit (Channel Material Specification Unit).

The Channel Material Specification Unit may specify or characterize the study segment's channel material. The channel material may be expressed as a quantitative number (e.g., a statistical average of the length of the intermediate axis of the channel material) and, in the Rosgen classification system, as a qualitative class (e.g., bedrock, boulders, cobble, gravel, sand, or silt/clay) which may be based on the quantitative value.

There may be fields for both the quantitative values and the qualitative classification. The system's cross-integration and data sharing between modules may enable these benefits because the system utilizes data and information from the Pebble Count Module for this unit. The system may analyze each available existing Pebble Count file(s) within the segment to determine their quantitative average substrate size (e.g., the d50 value). There may be a field for each value and/or a field for the average d50 value. These may be editable fields that the user can alter or change. The system may include built-in safeguards to protect the quality of this unit's analysis. For example, the user may be prompted if there is are substantive differences in the values (e.g., typically occurs when a stream changes stream types within a segment and indicates that the boundaries should be revised). There may be a field for the overall classification of the segment's channel material specification (e.g., cobble).

The user may verify both the analytical results and the segment's specified classification. Once verified, the user may have completed the analysis required for a Level II classification. The system may save all the data to the file. The user may navigate to the Rosgen Classification Component.

The Rosgen Classification Component 1908 may use the information from the Level II Analysis Component and synthesize the information to determine the study segment's Rosgen classification and stream type. The component may include: Level II Rosgen Classification Unit, and the Parameter Summary and Range Comparison Unit.

The Level II Classification Unit may display the stream type and, if appropriate, any sub specification to the stream type. It may include a summary of the classification of the summary categories used for the classification.

The Parameter Summary & Range Comparison Unit may display the values used for the Rosgen classification and/or shows how the stream type was determined using the accepted Rosgen stream type flow chart. This may enable the user to quickly and visually double check the classification and/or verify the accuracy of their Level II analysis. This unit may compare the calculated values to the acceptable ranges for a specific category or parameter. This unit may set forth and/or identify information or data that is questionable or might suggest that there are issues with the classification or that the segment may need further subdivision. This may serve as a final verification and quality control of the Level II classification for the study segment.

The user may verify both the analytical results and the segment's specified classification. Once verified, the user may have completed the Level II classification. The system may save the data to the file. The user may navigate to the Implications Component.

The Implications Component 1912 may be where important information is provided based on the Rosgen classification for the chosen study segment. This component may present assessment and predictive information based on the stream type and Rosgen classification. This may include such factors as the sensitivity of the reach to disturbance, the controlling effects of vegetation within the study segment, the overall stability of the segment (e.g., likelihood of substantive change), and/or predict future change to the study segment.

This component may present and/or make recommendations on potential actions or activities that may take place and/or those that may be avoided in order to protect the function of the stream and to promote dynamic equilibrium, stream health, and overall watershed health.

The Rosgen Module may include Implementation Services 2002. Implementation Services 2002 may include RC User Interface Service 2004, Rosgen Data Store Service 2006, Rosgen Data Service 2008, and Rosgen Controller Service 2010.

The Rosgen User Interface Service 2004 may allow for communication between the user interface components. This service may act as an intermediary between components. Messages pertaining to specific user actions within one component may be broadcast to other components that require that information. A component may respond to user actions that take place in another component.

The Rosgen Data Store Service 2006 may provide a local, in-memory representation of the currently open Rosgen Classification file. This representation may be updated based on user actions. Other modules within the application may be synchronized to the current state of the Rosgen Classification file.

The Rosgen Data Service 2008 may provide an interface with the Server Application for purposes of storing and retrieving Rosgen Classification file data from the remote database. Rosgen Classification file data requests to the Server Application and responses from the Server Application may be routed through this service.

The Rosgen Controller Service 2010 may provide common methods for other Components and Services within the Rosgen Classification Module.

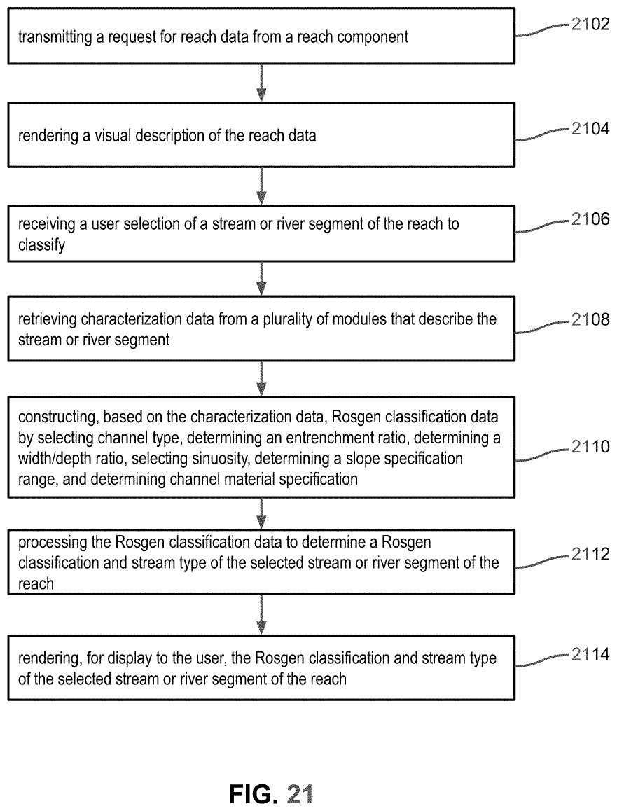

FIG. 21 shows a flowchart of a method for Rosgen classification. The method may be performed by systems and/or components described herein, including components from FIGS. 1-22. In block 2102, a computing system may transmit a request for reach data from a reach component. In block 2104, the computing system may render a visual description of the reach data. In block 2106, the computing system may receive a user selection of a stream or river segment of the reach to classify. In block 2108, the computing system may retrieve characterization data from a plurality of modules that describe the stream or river segment. In block 2110, the computing system may construct, based on the characterization data, Rosgen classification data by selecting channel type, determining an entrenchment ratio, determining a width/depth ratio, selecting sinuosity, determining a slope specification range, and determining channel material specification. In block 2112, the computing system may process the Rosgen classification data to determine a Rosgen classification and stream type of the selected stream or river segment of the reach. In block 2114, the computing system may render, for display to the user, the Rosgen classification and stream type of the selected stream or river segment of the reach.

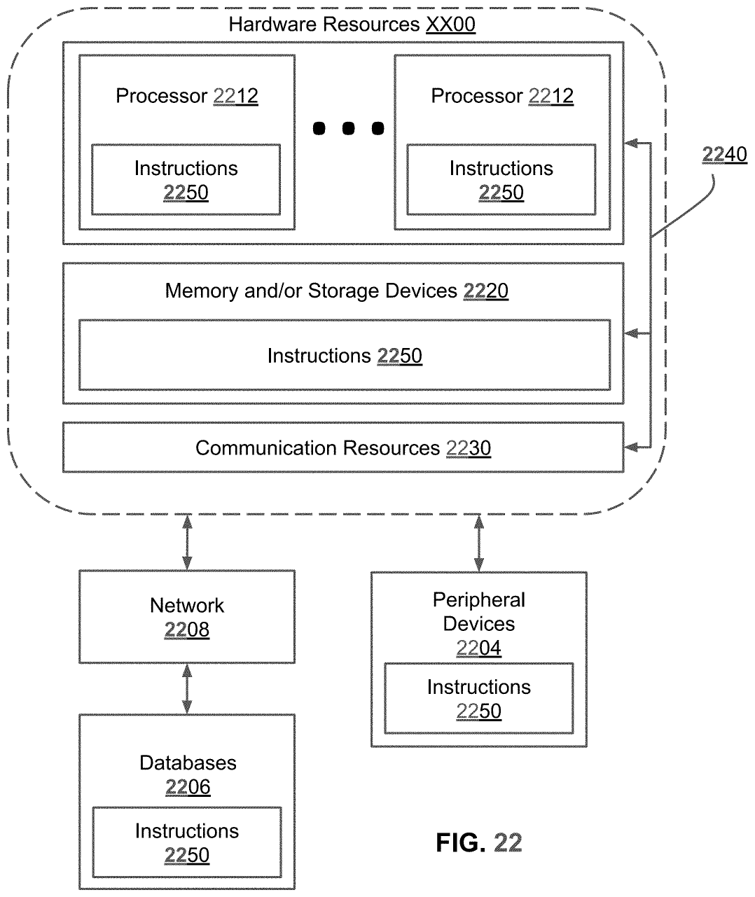

FIG. 22 is a block diagram illustrating components, according to some example embodiments, able to read instructions from a machine-readable or computer-readable medium (e.g., a machine-readable storage medium) and perform any one or more of the methodologies discussed herein. Specifically, FIG. 22 shows a diagrammatic representation of hardware resources 2200 including one or more processors (or processor cores) 2210, one or more memory/storage devices 2220, and one or more communication resources 2230, each of which are communicatively coupled via a bus 2240.

The processors 2210 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 2212 and a processor 2214. The memory/storage devices 2220 may include main memory, disk storage, or any suitable combination thereof.

The communication resources 2230 may include interconnection and/or network interface components or other suitable devices to communicate with one or more peripheral devices 2204 and/or one or more databases 2206 via a network 2208. For example, the communication resources 2230 may include wired communication components (e.g., for coupling via a Universal Serial Bus (USB)), cellular communication components, Near Field Communication (NFC) components, Bluetooth® components (e.g., Bluetooth® Low Energy), Wi-Fi® components, and other communication components.

Instructions 2250 may comprise system, a program, an application, an applet, an app, or other executable code for causing at least any of the processors 2210 to perform any one or more of the methodologies discussed herein. The instructions 2250 may reside, completely or partially, within at least one of the processors 2210 (e.g., within the processor's cache memory), the memory/storage devices 2220, or any suitable combination thereof. Furthermore, any portion of the instructions 2250 may be transferred to the hardware resources 2200 from any combination of the peripheral devices 2204 and/or the databases 2206. Accordingly, the memory of processors 2210, the memory/storage devices 2220, the peripheral devices 2204, and the databases 2206 are examples of computer-readable and machine-readable media.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more system or firmware programs, a combinational logic circuit, and/or other suitable hardware components that provide the described functionality. In some embodiments, the circuitry may be implemented in, or functions associated with the circuitry may be implemented by, one or more system or firmware modules. In some embodiments, circuitry may include logic, at least partially operable in hardware.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, system, and/or firmware.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and one or more clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking system, such as the system available from Novell®, Microsoft®, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Various techniques, or certain aspects or portions thereof, may take the form of program code (i.e., instructions) embodied in tangible media, such as floppy diskettes, CD-ROMs, hard drives, magnetic or optical cards, solid-state memory devices, a nontransitory computer-readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and nonvolatile memory and/or storage elements), at least one input device, and at least one output device. The volatile and nonvolatile memory and/or storage elements may be a RAM, an EPROM, a flash drive, an optical drive, a magnetic hard drive, or other medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Each computer system includes one or more processors and/or memory; computer systems may also include various input devices and/or output devices. The processor may include a general purpose device, such as an Intel®, AMD®, or other “off-the-shelf” microprocessor. The processor may include a special purpose processing device, such as ASIC, SoC, SiP, FPGA, PAL, PLA, FPLA, PLD, or other customized or programmable device. The memory may include static RAM, dynamic RAM, flash memory, one or more flip-flops, ROM, CD-ROM, DVD, disk, tape, or magnetic, optical, or other computer storage medium. The input device(s) may include a keyboard, mouse, touch screen, light pen, tablet, microphone, sensor, or other hardware with accompanying firmware and/or system. The output device(s) may include a monitor or other display, printer, speech or text synthesizer, switch, signal line, or other hardware with accompanying firmware and/or system.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, or off-the-shelf semiconductors such as logic chips, transistors, or other discrete components. A component may also be implemented in programmable hardware devices such as field programmable gate arrays, programmable array logic, programmable logic devices, or the like.

Components may also be implemented in system for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Several aspects of the embodiments described will be illustrated as system modules or components. As used herein, a system module or component may include any type of computer instruction or computer-executable code located within a memory device. A system module may, for instance, include one or more physical or logical blocks of computer instructions, which may be organized as a routine, program, object, component, data structure, etc., that perform one or more tasks or implement particular data types. It is appreciated that a system module may be implemented in hardware and/or firmware instead of or in addition to system. One or more of the functional modules described herein may be separated into sub-modules and/or combined into a single or smaller number of modules.

In certain embodiments, a particular system module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, system modules may be located in local and/or remote memory storage devices. In addition, data being tied or rendered together in a database record may be resident in the same memory device, or across several memory devices, and may be linked together in fields of a record in a database across a network.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of materials, frequencies, sizes, lengths, widths, shapes, etc., to provide a thorough understanding of embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/aspects/etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

What is claimed:

1. A system for Rosgen classification, the system comprising:
a segment specification component configured to retrieve reach data from a reach module, and receive a user selection of a stream or river segment of the reach to classify;
a level analysis component configured to retrieve and filter characterization data from a plurality of modules that describe the stream or river segment, wherein the characterization data is used to determine Rosgen classification data based on selecting channel type, determining an entrenchment ratio, determining a width/depth ratio, selecting sinuosity, determining a slope specification range, and determining channel material specification; and
a Rosgen classification component configured to process the Rosgen classification data and output a Rosgen classification and stream type of the selected stream or river segment of the reach.

2. The system of claim 1, wherein the plurality of modules comprise:
a cross-section analysis module configured to describe cross sections within a reach;
a longitudinal profile module configured to describe slope information, indicate channel features, and segment a longitudinal profile into channel feature segments; and
a pebble count module configured to describe channel material as a quantitative number and a qualitative class.

3. The system of claim 1, further comprising an implications component configured to determine sensitivity of the stream or river segment of the reach to disturbance, controlling effects of vegetation within the segment, and stability of the segment.

4. The system of claim 1, further comprising:
a data store service configured to provide a local, in-memory representation of a currently open Rosgen classification file; and
a data service configured to interface with a server application to store and retrieve Rosgen Classification file data from a remote database.

5. The system of claim 1, further comprising a survey data module configured to:
receive, process and verify survey data for watershed assessment and characterization; and
associate the verified data with an instrument data module, a longitudinal profile module and a cross-section module for further processing by each of the modules.

6. The system of claim 1, further comprising a remote database comprising the characterization data and in communication with the level analysis component.

2. A method of Rosgen classification, the method comprising:
transmitting a request for reach data from a reach component;
rendering a visual description of the reach data;
receiving a user selection of a stream or river segment of the reach to classify;
retrieving characterization data from a plurality of modules that describe the stream or river segment;
constructing, based on the characterization data, Rosgen classification data by:
determining a channel type;
determining an entrenchment ratio;
determining a width/depth ratio;
determining a sinuosity;
determining a slope specification range; and
determining channel material specification; and
processing the Rosgen classification data to determine a Rosgen classification and stream type of the selected stream or river segment of the reach; and
rendering, for display to the user, the Rosgen classification and stream type of the selected stream or river segment of the reach.

8. The method of claim 7, wherein retrieving characterization data from a plurality of modules that describe the stream or river segment further comprises retrieving the characterization data from a remote database.

9. The method of claim 7, wherein retrieving characterization data further comprises:
retrieving, from a cross-section analysis module configured to describe cross sections within a reach, a portion of the characterization data;
retrieving, from a longitudinal profile module configured to describe slope information, a portion of the characterization data; and
retrieving, from a pebble count module configured to describe channel material as a quantitative number and a qualitative class, a portion of the characterization data.

10. The method of claim 7, further comprising determining:
sensitivity of the stream or river segment of the reach to disturbance;
controlling effects of vegetation within the segment; and
stability of the segment.

11. The method of claim 7, further comprising:
receiving, processing and verifying survey data for watershed assessment and characterization; and
associating the verified data with an instrument data module, a longitudinal profile module and a cross-section module for further processing by each of the modules.

12. The method of claim 7, further comprising providing a local, in-memory representation of a currently open Rosgen classification file.

13. The method of claim 7, further comprising interfacing with a server application to store and retrieve Rosgen Classification file data from a remote database.

3. A computer program product comprising a computer-readable storage medium that stores instructions for execution by a processor to perform operations of a Rosgen classification system, the operations, when executed by the processor, to perform a method, the method comprising:
receiving reach data from a reach component;
receiving a user selection of a stream or river segment of the reach to classify;
retrieving, based on the user selection, characterization data from a plurality of components that describe the stream or river segment of the reach;
constructing, based on the characterization data, classification data comprising: a channel type, an entrenchment ratio, a width/depth ratio, a sinuosity classification, a slope specification range, and a channel material determination; and
processing the classification data to determine a Rosgen classification and stream type of the selected stream or river segment of the reach.

15. The computer program product of claim 14, wherein the method further comprises rendering a representation of the Rosgen classification of the selected stream or river segment of the reach.

16. The computer program product of claim 14, wherein the method further comprises rendering a representation of the stream type of the selected stream or river segment of the reach.

17. The computer program product of claim 14, wherein retrieving characterization data from a plurality of modules that describe the stream or river segment further comprises retrieving the characterization data from a remote database.

18. The computer program product of claim 14, wherein retrieving characterization data further comprises:
retrieving, from a cross-section analysis module configured to describe cross sections within a reach, a portion of the characterization data;
retrieving, from a longitudinal profile module configured to describe slope information, a portion of the characterization data; and
retrieving, from a pebble count module configured to describe channel material as a quantitative number and a qualitative class, a portion of the characterization data.

19. The computer program product of claim 14, further comprising determining sensitivity of the stream or river segment of the reach to disturbance.

20. The computer program product of claim 14, further comprising determining:
controlling effects of vegetation within the segment; or stability of the segment.
